(19) United States
(12) Patent Application Publication
(10) Pub. No.: US 2026/0214305 A1
(43) Pub. Date: Jul. 23, 2026

(54) GENERATING A SECURED ENHANCEMENT VIDEO LAYER INCLUDING A PERSONALIZED WATERMARK FOR PREVENTING UNAUTHORIZED VIDEO DATA DISTRIBUTION VIA PROCESSING CIRCUITRY

(71) Applicant: NAGRAVISION SÀRL, Cheseaux-sur-Lausanne (CH)

(72) Inventor: Benjamin GIDLEY, Cheseaux-sur-Lausanne (CH)

(73) Assignee: NAGRAVISION SÀRL, Cheseaux-sur-Lausanne (CH)

(21) Appl. No.: 19/567,539

(22) Filed: Mar. 16, 2026

Related U.S. Application Data
(63) Continuation of application No. PCT/EP2024/075403, filed on Sep. 11, 2024.
(60) Provisional application No. 63/582,709, filed on Sep. 14, 2023.

(51) Int. Cl. H04N 21/8358; G06F 21/16; H04N 19/30; H04N 19/467; H04N 21/234; H04N 21/258

(52) U.S. Cl. CPC H04N 21/8358; G06F 21/16; H04N 21/23418; H04N 21/258; H04N 19/30; H04N 19/467

(57) ABSTRACT

A method, device, and computer readable medium that applies a personalized watermark to an enhancement video layer, the enhancement video layer configured to adjust a quality level of a base video layer when applied to the base video layer, the base video layer having a first quality level, the base video layer generated from source video data.

### CROSS-REFERENCE TO RELATED APPLICATIONS

This application is a by-pass continuation of PCT/EP2024/075403 filed on Sep. 11, 2024, which claims priority to U.S. Provisional Patent Application No. 63/582,709, filed on Sep. 14, 2023, the disclosures of each of which are incorporated by reference herein in their entirety.

### FIELD OF THE DISCLOSURE

The present disclosure relates generally to watermarking.

### DESCRIPTION OF THE RELATED ART

A watermark can be a digital marker or identifier that is added to video data for copyright protection or content tracking. However, watermarking video data on a per user basis can be difficult and technologically challenging.

The foregoing description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

A first aspect of the present disclosure provides a method that includes applying a personalized watermark to an enhancement video layer, the enhancement video layer configured to adjust a quality level of a base video layer when applied to the base video layer, the base video layer having a first quality level, the base video layer generated from source video data.

A second aspect of the present disclosure provides a device that includes processing circuitry configured to execute the method of the first aspect of the present disclosure. The optional features set out above in respect of the method of the first aspect of the disclosure also apply equally well to the method which the processing circuitry of the apparatus of the second aspect of the disclosure is configured to execute.

A third aspect of the present disclosure provides a non-transitory computer-readable storage medium for storing computer-readable instructions that, when executed by a computer, cause the computer to perform the method of the first aspect of the disclosure. The optional features set out above in respect of the method of the first aspect of the disclosure also apply equally well to the method which the computer-readable instructions of the third aspect of the disclosure cause the computer to execute.

A fourth aspect of the present disclosure provides a method comprising: receiving, from a first device, a base video layer and an enhancement video layer with a personalized watermark applied to the enhancement video layer, the enhancement video layer configured to adjust a quality level of a base video layer when applied to the base video layer, the base video layer having a first quality level, the base video layer generated from source video data, the personalized watermark generated based on a session identification (ID); determining whether the base video layer and the enhancement video layer with the personalized watermark from the first device are unauthorized; and upon determining the received base video layer and the enhancement video layer with the personalized watermark from the first device are unauthorized, determining the session ID corresponding to the personalized watermark. Optional features set out above in respect of the method of the first aspect of the disclosure also apply equally well to the method of the fourth aspect of the disclosure.

A fifth aspect of the present disclosure provides an apparatus comprising processing circuitry configured to execute the method of the fourth aspect of the disclosure. The optional features set out above in respect of the method of the first aspect of the disclosure and the method of the fourth aspect of the disclosure also apply equally well to the method which the processing circuitry of the apparatus of the fifth aspect of the disclosure is configured to execute.

A sixth aspect of the present disclosure provides a non-transitory computer-readable storage medium for storing computer-readable instructions that, when executed by a computer, cause the computer to perform the method of the fourth aspect of the disclosure. The optional features set out above in respect of the method of the first aspect of the disclosure and the method of the fourth aspect of the disclosure also apply equally well to the method which the computer-readable instructions of the sixth aspect of the disclosure cause the computer to execute.

A seventh aspect of the present disclosure provides a method, comprising: receiving, from a first device, a combined video layer including a base video layer and an enhancement video layer with a personalized watermark applied to the enhancement video layer, the enhancement video layer configured to adjust a quality level of a base video layer when applied to the base video layer, the base video layer having a first quality level, the base video layer generated from source video data, the personalized watermark generated based on a session identification (ID); determining whether the combined video layer from the first device is unauthorized; and upon determining the received combined video layer from the first device is unauthorized, determining the session ID corresponding to the personalized watermark. Optional features set out above in respect of the method of the first aspect of the disclosure also apply equally well to the method of the seventh aspect of the disclosure.

An eighth aspect of the present disclosure provides an apparatus comprising processing circuitry configured to execute the method of the seventh aspect of the disclosure. The optional features set out above in respect of the method of the first aspect of the disclosure and the method of the seventh aspect of the disclosure also apply equally well to the method which the processing circuitry of the apparatus of the eighth aspect of the disclosure is configured to execute.

A ninth aspect of the present disclosure provides a non-transitory computer-readable storage medium for storing computer-readable instructions that, when executed by a computer, cause the computer to perform the method of the seventh aspect of the disclosure. The optional features set out above in respect of the method of the first aspect of the disclosure and the method of the seventh aspect of the disclosure also apply equally well to the method which the computer-readable instructions of the ninth aspect of the disclosure cause the computer to execute.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a system for preventing unauthorized video data distribution, according to an embodiment of the present disclosure.

FIG. 2 is a schematic describing the generating of an enhancement video layer with a personalized watermark and a base video layer using source video data, according to an embodiment of the present disclosure.

FIG. 3A shows a schematic of a method for applying a personalized watermark to an enhancement video layer and detecting tampering of the enhancement video layer, according to an embodiment of the present disclosure.

FIG. 3B shows a schematic of a method for applying a personalized watermark to an enhancement video layer and detecting tampering of the enhancement video layer, according to an embodiment of the present disclosure.

FIG. 3C is a flow chart for a method of applying the personalized watermark to the enhancement video layer and detecting tampering of the enhancement video layer, according to an embodiment of the present disclosure.

FIG. 4 is a flow chart describing the step of generating the base video layer having a lower quality level, according to an embodiment of the present disclosure.

FIG. 5 is a flow chart describing the step of generating the personalized watermark, according to an embodiment of the present disclosure.

FIG. 6 is a flow chart describing the step of determining the location for applying the personalized watermark, according to an embodiment of the present disclosure.

FIG. 7 is a flow chart describing the step of implementing the anti-piracy process, according to an embodiment of the present disclosure.

FIG. 8A shows a schematic of a method for applying a personalized watermark to an enhancement video layer and detecting a source device from a pirated video stream, according to an embodiment of the present disclosure.

FIG. 8B shows a schematic of a method for applying a personalized watermark to an enhancement video layer and detecting a source device from a pirated video stream, according to an embodiment of the present disclosure.

FIG. 8C is a flow chart for a method of applying the personalized watermark to the enhancement video layer and detecting a source device from a pirated video stream, according to an embodiment of the present disclosure.

FIG. 9 is a flow chart describing the step of implementing the anti-piracy process, according to an embodiment of the present disclosure.

FIG. 10 is a schematic of a user device for performing a method, according to an embodiment of the present disclosure.

FIG. 11 is a schematic of a hardware system for performing a method, according to an embodiment of the present disclosure.

FIG. 12 is a schematic of a hardware configuration of a device for performing a method, according to an embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Digital Rights Management (DRM) refers to methods, standards, and systems to protect copyrights and restrict the use of copyrighted digital data and media (e.g., from being stolen, shared, illegally distributed, etc.). DRM can protect the digital data and media, such as video data, as it is transmitted from a source, such as a server, to a target user, such as a customer. However, upon being received by the device of the user for displaying or for other methods of use, unauthorized users, such as hackers, attackers, pirates, etc. can attempt to obtain the video data and redistribute the video data. Thus, a watermarking process can be used to embed a marker (unique, personalized, tailored, customized, or otherwise identifying) into the video data that identifies the individual user.

Watermarking of video data can be used to embed information or a visual (or non-visual) marker into the video data, which can be distributed to a user or multiple users, to help prevent unauthorized distribution of the video data. However, watermarking the video data itself on a per user basis can be difficult and economically and technologically challenging. Therefore, a method for providing a layered watermark to corresponding video data while preserving performance and preventing the unauthorized distribution of the video data is desired.

If the video data provider discovers a device that is restreaming pirated content, they can extract the watermark to identify where the content was restreamed from. However, DRM and watermarking techniques can be defeated by pirates exposing the uncompressed source video. As more open device DRM systems are being controlled by client side devices, providers have encountered new challenges in correcting such breakages.

For over-the-top (OTT) platforms, it can be difficult to secure the video data when on consumer devices. DRM can help, but High-bandwidth Digital Content Protection (HDCP), a form of digital copy protection to prevent copying of digital audio and video data as it travels across devices, can be broken and allow for digital extraction. Some watermarking processes can be implemented, but are expensive to deploy. Many open devices include a platform DRM, but the DRM can be hacked using a key extractor from the trusted execution environment (TEE).

Thus, a method is described herein that uses encoded layers when streaming video data to user or client devices. The method can include applying a personalized watermark to an enhancement video layer that is configured to adjust a quality level of a base video layer when combined or applied to the base video layer. In the context of video encoding, a layer can typically refer to a specific component or level of a video stream that includes a subset of the video data. The layer can have different meanings and applications based on the implemented video coding standard. Notably, layers can be used in video coding and compression processes to achieve various metrics, e.g., scalability, adaptability, and efficiency. Advantageously, even if the DRM and/or HDCP are broken by the unauthorized user, the unauthorized user can either obtain the base video layer that will have a poor quality level that is difficult for a user to watch, or the unauthorized user will obtain the combined base video layer with the watermarked enhancement video layer, thus providing identifying data. In another advantage, the method can be performed by any server having source video data from which the base video layer is generated, such as a client server or a provider server.

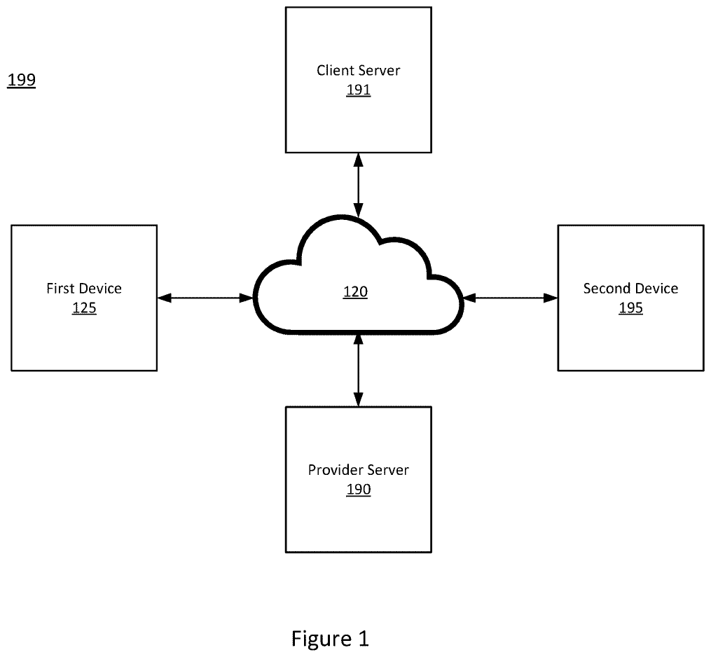

To this end, referring now to the Drawings, FIG. 1 is a schematic view of a system 199 for preventing unauthorized video data or stream distribution, according to an embodiment of the present disclosure. In an embodiment, the system 199 includes a first device 125 in network communication with one or more servers, such as a provider server 190 and a client server 191, as well as one or more other devices, such as a second device 195, over or via a communication network 120, e.g., an Internet connection, Bluetooth, etc. The devices can be connected via a wired or a wireless connection. The communication network 120 can include more than one communication network, e.g., more than one local area network (LAN).

In an embodiment, the first device 125 can be configured to process or display video data received from the provider server 190 and/or the client server 191. The provider server 190 and/or the client server 191 can be configured to initiate a communication session with the first device 125 or any other devices in the network 120 to share data.

In an embodiment, the provider server 190 and the client server 191 can have access to digital content, such as source video data (raw video data), which can be provided or transmitted to a requesting device, such as the first device 125. For example, the provider server 190 and the client server 191 can access and provide or transmit the digital content to the first device 125 in a video-on-demand (VOD) context. Of course, transmitting the digital content as source video data can be challenging due to the large size and bandwidth requirements. Thus, the provider server 190 and the client server 191 can perform various processes, including video encoding, content protection (applying the DRM), and adaptive bitrate streaming (transmitting various quality versions of the video data based on network and device capabilities).

In an embodiment, the provider server 190 can be configured to access the source video data, encode the source video data for delivery to a requesting device, and transmit the source video data in the encoded format. For example, the provider server 190 can transmit the source video data in the encoded format directly to the first device 125. For example, the provider server 190 can transmit the video data in the encoded format indirectly to the first device 125, where the client server 191 receives the video data in the encoded format from the provider server 190 before the client server 191 transmits the video data in the encoded format to the first device 125. In the latter example, the client server 191 can adjust or modify the video data further if desired before the transmitting to the first device 125. For example, the client server 191 may not have access to the digital content (source video data), but can be the entity configured to interface with the requesting devices (the first device 125). Additionally or alternatively, the client server 191 can also have access to the digital content (source video data) and be configured to encode the video data and transmit the video data in the encoded format to the first device 125 during the communication session. In either embodiment, the client server 191 can be separate from the provider server 190 and configured to provide client side security, where the client can be a streaming service such as Netflix, Applet, Hulu, Disney+, etc.

In an embodiment, the client server 191 can be configured to generate security credentials and deploy the security credentials to each of the networked devices. The client server 191 can be in communication with the first device 125 via the communication session that is secured using the security credentials generated by the client server 191.

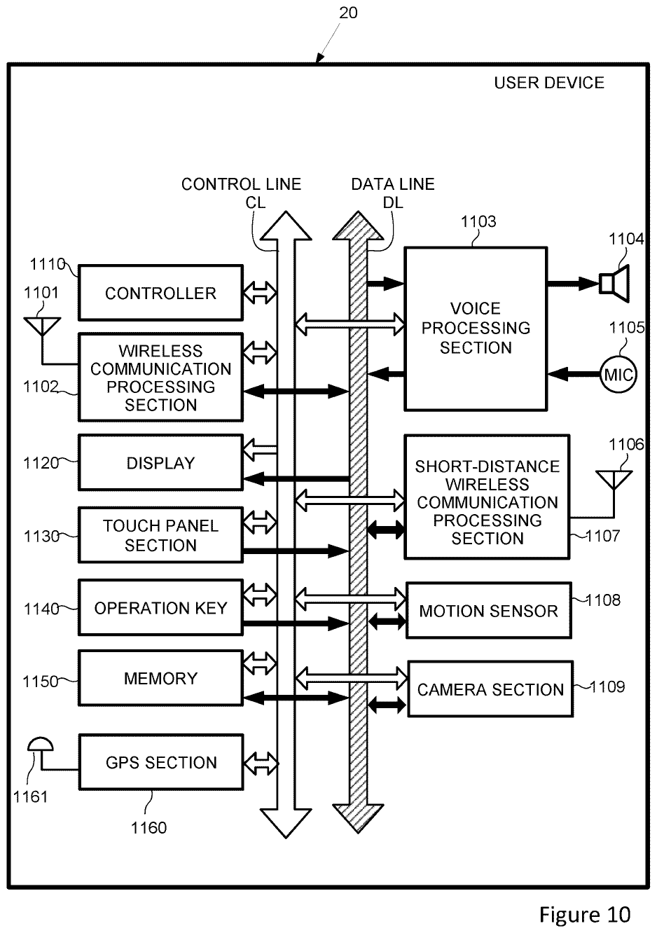

In an embodiment, the first electronic device 125, the second electronic device 195, the provider server 190, and the client server 191 can include one or more processors (for example, a central processing unit (CPU)), among other components (discussed in more detail in FIGS. 10-12). An application can be installed or accessible on the first electronic device 125, the second electronic device 195, the provider server 190, and the client server 191 for executing the methods described herein. The application can also be integrated into an operating system (OS) of the first electronic device 125, the second electronic device 195, the provider server 190, and the client server 191. The first device 125 can be, for example, a user device such as a computer, tablet, smartphone, or a mobile device. The first device 125 can be configured to display content, such as received video data. The provider server 190 and the client server 191 can each be, or each comprise, one or more computer systems or server computers. The provider server 190 and the client server 191 can be operated by separate entities, or by the same entity.

In an embodiment, the client server 191 can receive data from the first device 125 during the communication session, such as security credentials, identification data related to the first device 125, identification data related to the user of the first device 125, status data or indicators related to the video data, executable instructions, etc.

In an embodiment, the first device 125 can receive data from or transmit data to the second device 195, and vice versa. For example, the unauthorized user can use the second device 195 to redistribute pirated video data obtained from the first device 125. Similarly, the provider server 190 and the client server 191 can receive data from or transmit data to the second device 195, and vice versa. For example, the provider server 190 and the client server 191 can receive the pirated video data being transmitted or redistributed from the second device 195.

In order to help prevent the unauthorized redistribution of the video data, an upscaling strategy using multiple layers can be implemented to force the unauthorized user to either accept a subset of video data having a quality level that is poor or difficult to view, or accept the video data having a quality level that is high and acceptable for viewing, but includes a personalized watermark.

In an embodiment, an encoding process, such as Low Complexity Enhancement Video Coding (LCEVC), can be used to generate the subset of video data having the poor quality level as a first layer plus a second layer configured to adjust or modify the first layer with the poor quality level. In addition to improving the quality of the video data, the LCEVC process improves compression efficiency while maintaining low computational complexity. This can reduce bandwidth requirements and improve performance of video streaming for applications where bandwidth requirements are important, such as online video streaming. The LCEVC process can enhance or augment existing video coder-decoders (codecs), such as H.264 or H.265, by adding an additional layer of encoding, known as an enhancement video layer. The enhancement video layer can include data or information to improve the quality level of the first layer, which can be decoded by receiving devices configured to display the video data, such as the first device 125.

In an embodiment, the LCEVC process can include encoding a base layer of video data, encoding the enhancement video layer, and the eventual combination of the base layer and the enhancement video layer. For the base layer encoding, a codec such as H.264 or H.265 (HEVC) can be used to generate compressed video data from source video data. Thus, the base layer represents core content of the source video data and is essentially the foundation of the encoded video data. For the enhancement video layer encoding, the LCEVC process generates the enhancement video layer to include data that can modify or adjust the video data in the base layer. Generally, the enhancement video layer data is complementary data to the encoded video data in the base layer that improves the quality level of the encoded video data. The enhancement video layer data can be generated or encoded based on differences between the source video data and an enhanced version of the source video data. Notably, the enhancement video layer data can typically be smaller in size compared to encoding the entire enhanced video from the source video data. Thus, a size and bandwidth efficiency can be realized. To generate the enhanced version of the source video data, the displaying device, such as the first device 125, can include a decoder configured to combine the received base layer and the received enhancement video layer. For example, the enhancement video layer can be overlaid on the base layer. That is, by applying the enhancement video layer to the base layer, the decoder can enhance the quality of the base layer video data to generate or yield a higher quality video than what the video data in the base layer alone would provide.

As previously described, the LCEVC process can deliver the higher quality video while reducing the bandwidth requirements. Additionally, the enhancement video layer can include more than just the complementary video data to the base layer video data and can be used to provide a way to identify a user or device receiving the base layer and the enhancement video layer. Notably, the multiple layer strategy can aid in preventing unauthorized users from obtaining the enhanced base layer video data without an identifying feature.

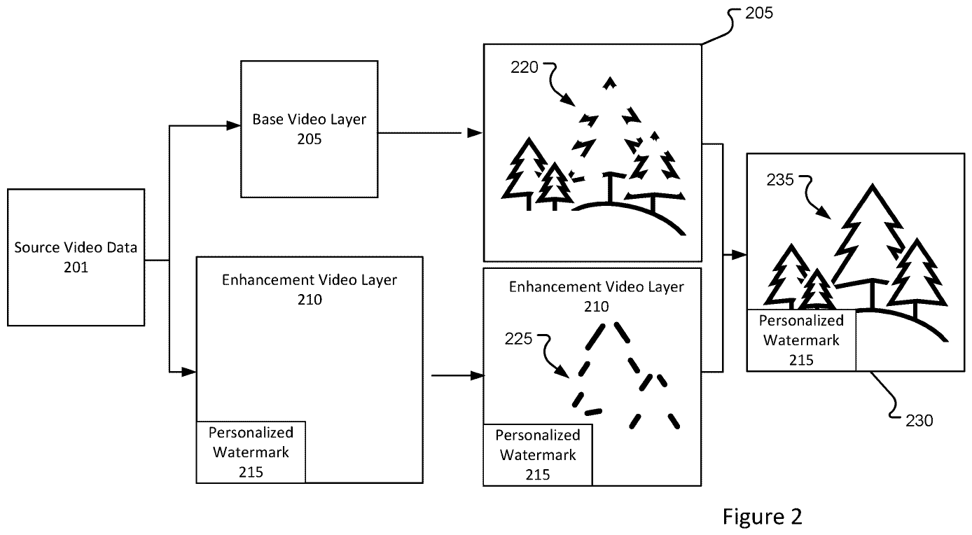

To this end, FIG. 2 is a schematic describing the generating of an enhancement video layer 210 with a personalized watermark 215 and a base video layer 205 using source video data 201, according to an embodiment of the present disclosure. In an embodiment, the source video data 201 can be used to generate the base video layer 205 and the enhancement video layer 210. The source video data (and other video data described herein) can be comprised of a plurality of frames spanning a period of time or duration. Generally, standard definition (SD) video does not need DRM, high definition (HD) video can use DRM while also being supported by software security measures, and 4k video can use DRM while also being supported by hardware security measures. However, hardware security supported DRM can be hacked. For example, TEEs on ARM platforms can be hacked. Thus, the method described herein can use a combination of hardware, software, and layered video to prevent unauthorized users from obtaining the high quality video, such as any high quality video based on the source video data 201. For example, the source video data can be in 4K, 8K, or the like.

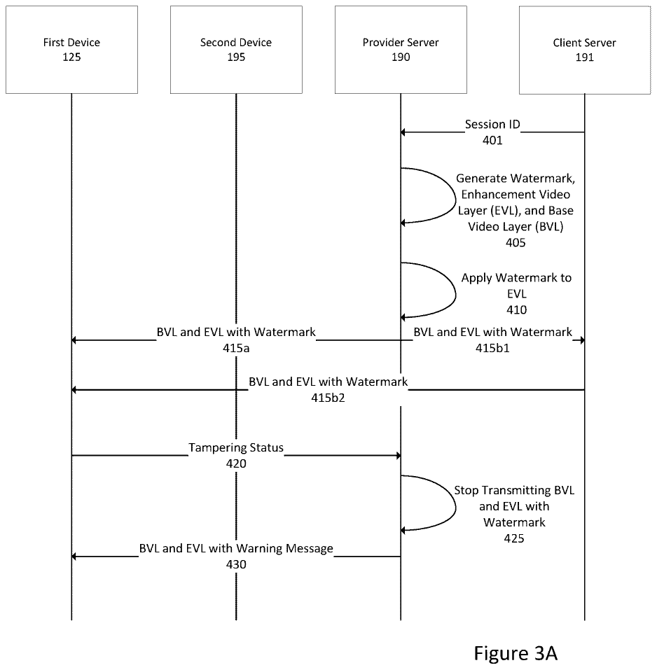

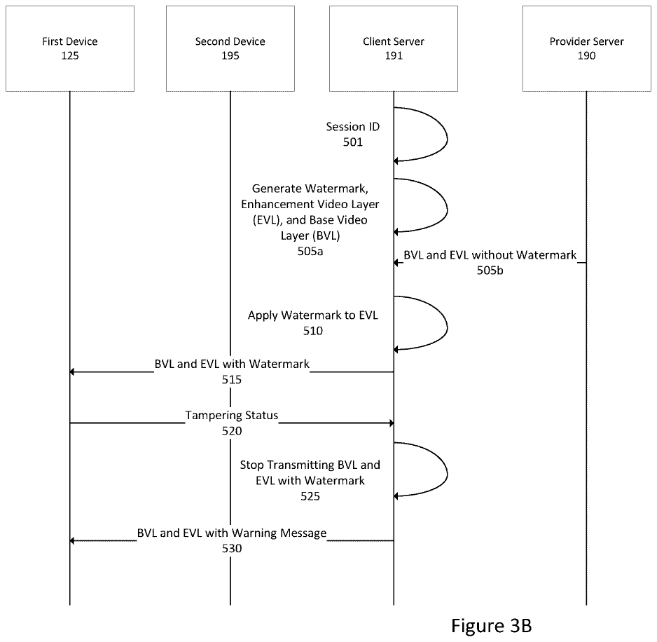

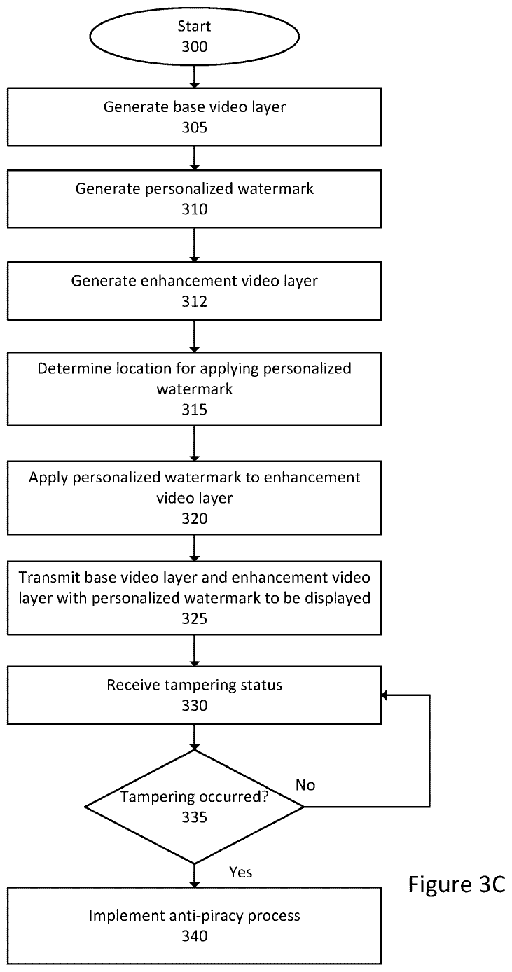

FIG. 3A and FIG. 3B show schematics of methods for applying a personalized watermark to an enhancement video layer and detecting tampering of the enhancement video layer, according to an embodiment of the present disclosure. FIG. 3A and FIG. 3B will be described herein to provide an overview of the methods, and in particular, the method described in FIG. 3C.

In brief, the method can encode the lower resolution video using a base video codec, such as H.264 or HEVC, which compresses the source video data into the base video layer 205 with a first quality level of video quality and a compression efficiency. Generally, the first quality level of the base video layer 205 can be similar to the SD video quality. Then, a difference or delta between the lower resolution (the base video layer 205) and the top resolution (the source video data 201) can be encoded with a codec for enhancement to generate the enhancement video layer 210. The enhancement video layer 210 can thus include the information or data needed to reconstruct the differences and enhance the base video layer 205. This can be achieved by applying various transform and quantization techniques to a residuals signal or layer. Example use cases for the method described herein can include VOD and live streaming, and each use case can benefit from a different type of encoding. For example, for VOD, a constant rate factor (CRF) encoding can be used, while for live streaming, a constant bitrate (CBR) encoding can be used.

As shown in FIG. 2, the base video layer 205 can include an area of interest (AOI) 220 which has been encoded via the base video codec and therefore can appear different from the source video data 201. For example, the AOI 220 includes trees which have been compressed and the data for the base video layer 205 therefore is different from the source video data 201. Thus, the enhancement video layer 210 can include enhancement data 225 that is the differences between the base video layer 205 and the source video data 201. The two layers 205, 210 can be combined (or the enhancement video layer 210 overlaid on the base video layer 205), to generate a combined video layer 230. Notably, the enhancement video layer 210 can adjust or modify or enhance the base video layer 205 to obtain a second quality level. As shown, the combined video layer 230 can include an enhanced AOI 235 where the missing portions of the trees in the base video layer 205 appear to be filled. Thus, the second quality level, which describes the combined video layer 230, can be better or higher or improved compared to the first quality level that describes the base video layer 205.

With reference to FIG. 3A and FIG. 3B, the encoding of the base video layer 205 and the enhancement video layer 210 are shown as step 405 in FIG. 3A and step 505a in FIG. 3B. In step 405 of FIG. 3A, the provider server 190 can generate the base video layer 205 and the enhancement video layer 210 using an encoding process. Here, the provider server 190 can have access to the digital content (source video data 201). In step 505a of FIG. 3B, the client server 191 can generate the base video layer 205 and the enhancement video layer 210 using an encoding process. Here, the client server 191 can have access to the digital content (source video data 201).

Additionally or alternatively, in an embodiment, the client server 191 can receive the base video layer 205 and the enhancement video layer 210 already encoded from the provider server 190. Thus, the only process the client server 191 can perform can be the applying of the personalized watermark 215 to the enhancement video layer 210. With reference to FIG. 3B, in step 505b, the client server 191 receives the base video layer 205 and the enhancement video layer 210 already encoded from the provider server 190. Here, the client server 191 may not have access to the digital content (source video data 201).

In an embodiment, the base video layer 205 can also be generated with a purposefully included additional degradation to the SD video data in order to further increase the difficulty of viewing the base video layer 205. While the SD video can be difficult to view, the additional degradation can compound the difficulty or render the base video layer 205 unwatchable. For example, the location of the AOI 220 can be determined and the source video data at the location of the AOI 220 can be modified before or after encoding. The modification can include, for example, adjusting a chroma value of pixels at the location of the AOI 220, removing the pixels at the location of the AOI 220 entirely (and moving the pixels to the enhancement video layer 210), or adding an obscuring feature at the location of the AOI 220, among others. For example, the modification can use facial recognition and blur any detected faces using a transform or extracting key pixels. For example, the modification can replace an area identified by the underlying codec (e.g., H.264) using Motion Compensation/Motion Vectors in the base video layer 205 with black pixels, and then correct the area having black pixels in the enhancement layer 210. This can be bandwidth efficient since codecs can optimize regular black shapes so the bitmaps from the base video layer 205 are moved to the enhancement video layer 210. The modification need not affect only video data at the location of the AOI 220, and instead, can affect all video data in the base video layer 205. For example, a color channel for all of the pixels can be removed, a chroma shift can be applied to all of the pixels, or a pattern of the modification can be applied, among others.

In an embodiment, the enhancement video layer 210 can be leveraged to include the personalized watermark 215. The personalized watermark 215 can be a digital marker or identifier that is added to video data for copyright protection or content tracking. The personalized watermark 215 can be added to videos in a way that makes them visible or non-visible to viewers. The personalized watermark 215 can also be added and arranged in the enhancement video layer 210 in such a way that avoids obstructing or purposefully obstructs the enhanced AOI 235. As shown, the personalized watermark 215 can be arranged to avoid obstructing the enhanced AOI 235 in the combined video layer 230.

The personalized watermark 215 can be, for example, text, a logo, an image, or a pattern, or a combination of the aforementioned, among others. The personalized watermark 215 can be customized on a per user or per device basis to include device or user information that are unique to the device or user. For example, each of the text, logo, image, pattern, or combination thereof can be unique to the device or user. The information unique to the device or user can be related to a device hardware ID, anonymized device ID, device private identity certificates, user ID, user email address, IP address, password, device model, geolocation, browser fingerprint, or any data that can be used to fingerprint the user or device. For example, the personalized watermark 215 can be the IP address of the device in a text format and applied to the enhancement video layer 210.

In an embodiment, generating the personalized watermark 215 to include the unique, customized, identifying, or personalized information can be advantageous since multiple users can be receiving the same base video layer 205, and the personalized watermark 215 can be tailored per user or per receiving device for later identification if needed. Since each receiving device can be unique based on hardware specifications, account information, geographic information, user information, etc., the unique or personalized information can be used to generate the personalized watermark 215. The personalized watermark 215 can be generated based on information related to, for example, the device hardware ID as previously mentioned, where the hardware ID can be a device serial number, or a model number, or a combination of both. For example, the personalized watermark 215 can be generated based on a combination of device hardware ID and specific user information, such as the device serial number and the user ID. The personalized watermark 215 can be the result of a mathematical transform using the serial number and the user ID and be in a text format. For example, the personalized watermark 215 can be in text format and based on an input password or passphrase by the user. For example, the personalized watermark 215 can be in text format and based on an input password with a mathematical transform applied. For example, the personalized watermark 215 can be in image format and based on an image of the user. For example, the personalized watermark 215 can be in image format and based on an icon selected by the user. For example, the personalized watermark 215 can be in image format and based on a user avatar generated by the user. For example, the personalized watermark 215 can be in image format and based on a pattern or motif selected by the user. For example, the personalized watermark 215 can be in image format and based on a drawing drawn by the user. For example, the personalized watermark 215 can be in image format and based on an input image input by the user with a mathematical transform applied to pixels of the input image. For example, the personalized watermark 215 can be in video format and based on a video clip selected by the user. For example, the personalized watermark 215 can be in audio format and based on an input audiogram by the user. For example, the personalized watermark 215 can be in image format and based on a combination of the image of the user and the selected motif, wherein the image of the user can be transformed by the motif.

In an embodiment, the aforementioned related information can be provided in a session ID transmitted by the first device 125 to the client server 191 via a session token. The session ID can be a number that identifies the communication session and associated entities. For example, the session ID can identify a specific user streaming or watching specific digital content. Notably, the same user streaming or watching different digital content can be provided a different session ID.

With reference to FIG. 3A and FIG. 3B, the generating of the personalized watermark 215 is also shown as step 405 in FIG. 3A and step 505 in FIG. 3B. In step 405 of FIG. 3A, the provider server 190 can generate the personalized watermark 215. In step 505 of FIG. 3B, the client server 191 can generate the personalized watermark 215.

In an embodiment, a watermark template can determine a location in the enhancement video layer 210 for applying the personalized watermark 215. The watermark template can be configured to analyse the source video data 201 and/or the base video layer 205 and/or the enhancement video layer 210, frame by frame, to detect the AOI 220 and a location of the AOI 220 (which will also generally correspond to a location of the enhancement data 225 in the enhancement video layer 210 and a location of the enhanced AOI 235 in the combined video layer 230). Notably, the watermark template can determine the location of the AOI 220 as the location changes over the duration of the base video layer 205 and adjust the location for applying the personalized watermark 215 over the duration of the base video layer 205. Additionally or alternatively, the watermark template can be configured to analyse the enhancement video layer 210 to detect an AOI in the residuals signal and a location of the AOI in the residuals signal.

In an embodiment, the watermark template can determine the location in the enhancement video layer 210 for applying the personalized watermark 215 by applying an inversion process to the enhancement layer 210. The inversion process can include analysing a density of the video data in the enhancement video layer 210 comparing transparent pixels with those containing more data, and identifying areas with lower video data density and providing a mask to the personalized watermark 215 to apply to the identified areas. That is, the mask can be used to define the watermark template, which in turn can be used to apply the personalized watermark 215.

In an embodiment, the watermark template can use the transparency, brightness, hue and saturation to indicate areas of the video which are optimal for inserting watermark data. The process of pre-calculating this in a template enables easier personalization of the watermark.

In an embodiment, the watermark template can be defined to extract details from the source video (e.g. face details, or removing pixels in a known shape), thereby providing an area for the details to be re-inserted in the overlay and to add a watermark to the reinserted data.

In an embodiment, the provider server 190 or the client server 191 can apply the personalized watermark 215 to the enhancement video layer 210, which can be a secured process to further prevent or resist removal or extraction of the personalized watermark 215 from the enhancement video layer 210. The first device 125 can play or display the base video layer 205 protected by DRM. The first device 125 can also combine the base video layer 205 with the enhancement video layer 210 to be displayed. Notably, since the removal or extraction of the personalized watermark 215 from the enhancement video layer 210 can be very difficult, an unauthorized user trying to pirate the video from the combined video layer 230 can be left with two options: only obtain the base video layer 205 with the first quality level that is generally difficult to view, or obtain both the base video layer 205 and the enhancement video layer 210 with the personalized watermark 215, where the personalized watermark 215 can include personalized information that can identify the unauthorized user and/or the device from which the unauthorized user is pirating or obtaining the combined video layer 230.

With reference to FIG. 3A and FIG. 3B, the applying of the personalized watermark 215 to the enhancement video layer 210 is shown as step 410 in FIG. 3A and step 510 in FIG. 3B. In step 410 of FIG. 3A, the provider server 190 can apply the personalized watermark 215 to the enhancement video layer 210. In step 505 of FIG. 3B, the client server 191 can apply the personalized watermark 215 to the enhancement video layer 210.

In an embodiment, an A/B watermarking process can be used when applying the personalized watermark to the enhancement video layer 210. The A/B watermarking process, within the context of applying the watermark to the enhancement video layer 210, can include generating a first copy (herein referred to as “copy A”) of the enhancement layer 210 and a second copy (herein referred to as “copy B”) of the enhancement layer 210, as well as generating a first personalized watermark of the personalized watermark 215 (herein referred to as “watermark A”) and a second personalized watermark of the personalized watermark 215 (herein referred to as “watermark B”). In an embodiment, the source video data 201 can be duplicated into a first set of a plurality of segments (herein referred to as “segments in segment set A”) and a second set of the plurality of segments (herein referred to as “segments in segment set B”), where the plurality of segments are a same period of time or duration and in a same order between the segment set A and the segment set B. Further, the watermark A can be applied to the copy A of the enhancement layer 210, the watermark B can be applied to the copy B of the enhancement layer 210, the segments in segment set A can have the copy A of the enhancement layer configured to adjust the quality level of the segments in segment set A, and the segments in segment set B can have the copy B of the enhancement layer 210 configured to adjust the quality level of the segments in segment set B. The provider server 190 and/or the client server 191 can transmit the segments in segment set A with the corresponding copy A of the enhancement layer 210 (herein referred to as “stream A”) and the segments in segment set B with the corresponding copy B of the enhancement layer 210 (herein referred to as “stream B”). Notably, an entirety of both streams need not be sent, but rather, a unique stream can be generated comprised of portions of the stream A and the stream B that can be unique to the receiving device (e.g., the first device 125). As a reminder, the segments of segment set A and the segments of segment set B are watermarked with the corresponding A or B watermark, therefore generating a unique, identifying watermark sequence unique to the receiving device. Upon receiving and analysing a pirated video stream, the unique, identifying watermark sequence can be determined and used to identify the receiving device.

In an embodiment, a communication session can be established between the first device 125 and the client server 191. The communication session can be identified via the session ID, which can be included in the session token transmitted to the client server 191. Advantageously, this can help prevent the unauthorized user from distributing the pirated video data while also providing a method of identifying the source device from which the unauthorized user obtained the video data.

In the context of identifying the communication session, in step 401 of FIG. 3A, the provider server 190 can determine the session ID by receiving the session ID from the client server 191. In step 501 of FIG. 3B, the client server 191 can determine the session ID by inspecting the session token including the session ID when the communication is established between the first device 125 and the client server 191.

In an embodiment, the client server 191 can transmit the enhancement video layer 210 with the personalized watermark 215 and the base video layer 205 to the first device 125. The first device 125, using the decoder on the first device 125, can combine the enhancement video layer 210 with the personalized watermark 215 and the base video layer 205 to generate the combined video layer 230 and display the combined video layer 230.

In an embodiment, the provider server 190 can transmit the enhancement video layer 210 with the personalized watermark 215 and the base video layer 205 to the first device 125. The first device 125, using the decoder on the first device 125, can combine the enhancement video layer 210 with the personalized watermark 215 and the base video layer 205 to generate the combined video layer 230 and display the combined video layer 230.

In an embodiment, the provider server 190 can transmit the enhancement video layer 210 with the personalized watermark 215 and the base video layer 205 to the client server 191, and the client server 191 can again transmit the enhancement video layer 210 with the personalized watermark 215 and the base video layer 205 to the first device 125. Here, the client server 191 need not generate the transmitted materials.

With reference to FIG. 3A and FIG. 3B, the transmitting of the base video layer 205 and the enhancement video layer 210 with the personalized watermark 215 is shown as step 415a or step 415b1 in FIG. 3A and step 515 in FIG. 3B. In step 415a of FIG. 3A, the provider server 190 can transmit the base video layer 205 and the enhancement video layer 210 with the personalized watermark 215 to the first device 125. Additionally or alternatively, in step 415b1 of FIG. 3A, the provider server 190 can transmit the base video layer 205 and the enhancement video layer 210 with the personalized watermark 215 to the client server 191, and in step 415b2, the client server 191 can transmit the base video layer 205 and the enhancement video layer 210 with the personalized watermark 215 to the first device 125. Here, the provider server 190 can have access to the digital content (source video data 201) while the client server 191 can be restricted from accessing the digital content (source video data 201). In step 515 of FIG. 3B, the client server 191 can transmit the base video layer 205 and the enhancement video layer 210 with the personalized watermark 215 to the first device 125.

In an embodiment, the first device 125 can communicate with the provider server 190 or the client server 191 constantly or with a certain frequency. The first device 125 can transmit the tampering status at the certain frequency as a way to continually provide authorization of layer delivery. The tampering status can indicate whether an unauthorized user has attempted to tamper with the enhancement video layer 210. For example, the unauthorized user can attempt to remove the personalized watermark 215 from the enhancement video layer 210. In such a scenario, the first device 125 can monitor an integrity of an application running a video platform, the device itself (e.g., the first device 125), and a watermarking process by applying software security techniques such as code signing, run time code verification, obfuscation, parallel code paths on a client (e.g., the client server 191) and/or a server (e.g., the provider server 190), and result comparison and remote attestation. When tampering is detected, this can be signaled to the server by providing a canary message attached to a fetch request for the enhancement layer 210 that changes if any of the applied security techniques are disabled. The canary message can include multiple status checks and the server can have a set of rules to define which checks (or combination of checks) must pass for the delivery or transmission to be consider “tampered”.

With reference to FIG. 3A and FIG. 3B, the receiving of the tampering status is shown as step 420 in FIG. 3A and step 520 in FIG. 3B. In step 420 of FIG. 3A, the provider server 190 can receive the tampering status. In step 520 of FIG. 3B, the client server 191 can receive the tampering status.

In an embodiment, upon receiving a tampering status that indicates tampering has occurred, an anti-piracy process can be implemented. The anti-piracy process can include stopping the transmitting of the base video layer 205 and/or the enhancement video layer 210 with the personalized watermark 215. Notably, the base video layer 205 can optionally still be transmitted without worry of the base video layer 205 being pirated since the first quality level makes the SD video already difficult to view. In effect, this can relegate the unauthorized user to only obtaining and viewing (or distributing) the SD video quality of the base video layer 205 in the optional scenario where the base video layer 205 is still transmitted. Otherwise, the unauthorized user stop receiving any video data at all.

With reference to FIG. 3A and FIG. 3B, the stopping of the transmitting of the base video layer 205 and/or the enhancement video layer 210 with the personalized watermark 215 is shown as step 425 in FIG. 3A and step 525 in FIG. 3B. In step 425 of FIG. 3A, the provider server 190 can stop the transmitting of the base video layer 205 and/or the enhancement video layer 210 with the personalized watermark 215. In step 525 of FIG. 3B, the client server 191 can stop the transmitting of the base video layer 205 and/or the enhancement video layer 210 with the personalized watermark 215.

In an embodiment, the anti-piracy process can include applying a warning message to the enhancement video layer 210 and transmitting the enhancement video layer 210 with the warning message (along with the base video layer 205). The warning message can include a graphic or text, and the warning message can be visible when applied to the enhancement video layer 210. For example, the words “STOP PIRATING THIS VIDEO” can be applied to the enhancement video layer 210 as the warning message, which can obscure some or most of the base video layer 205 when the enhancement video layer 210 is overlaid.

With reference to FIG. 3A and FIG. 3B, the transmitting of the base video layer 205 and the enhancement video layer 210 with the warning message is shown as step 430 in FIG. 3A and step 530 in FIG. 3B. In step 430 of FIG. 3A, the provider server 190 can transmit the base video layer 205 and the enhancement video layer 210 with the warning message. In step 530 of FIG. 3B, the client server 191 can transmit the base video layer 205 and the enhancement video layer 210 with the warning message.

FIG. 3C is a flow chart for a method 300 of applying the personalized watermark 215 to the enhancement video layer 210 and detecting tampering of the enhancement video layer 210, according to an embodiment of the present disclosure.

In an embodiment, with reference to step 405 of FIG. 3A and step 505 of FIG. 3B, at step 305, the base video layer 205 can be generated. As previously described, a base video codec such as H.264, HEVC, or other codec can be used to compress the source video data 201. For example, the provider server 190 can generate the base video layer 205 based on the source video data 201. For example, the client server 191 can generate the base video layer 205 based on the source video data 201.

In an embodiment, with reference to step 405 of FIG. 3A and step 505a of FIG. 3B, at step 310, the personalized watermark 215 can be generated. For example, the provider server 190 can generate the personalized watermark 215. For example, the client server 191 can generate the personalized watermark 215.

In an embodiment, with reference to step 405 of FIG. 3A and step 505a of FIG. 3B, at step 312, the enhancement video layer 210 can be generated. As previously described, the enhancement video layer 210 can include enhancement data 225 that are the differences between the base video layer 205 and the source video data 201. A codec configured to encode the enhancement data 225 can be used. For example, the provider server 190 can generate the enhancement video layer 210. For example, the client server 191 can generate the enhancement video layer 210.

In an embodiment, at step 315, a location in the enhancement video layer 210 for applying the personalized watermark 215 can be determined. For example, the location can be where the AOI 220 and/or the enhancement data 225 are not arranged when combined in the combined video layer 230, and the personalized watermark 215 can be applied such that the enhanced AOI 235 in the combined video layer 230 is not obscured. That is, the location of the enhanced AOI 235 in the combined video layer 230 can have a corresponding location in the enhancement video layer 210, and the personalized watermark 215 can be applied outside of the corresponding location in the enhancement video layer 210 (or at the corresponding location in the enhancement video layer 210 in order to obscure the enhanced AOI 235). For example, the provider server 190 can determine the location in the enhancement video layer 210 for applying the personalized watermark 215. For example, the client server 191 can determine the location in the enhancement video layer 210 for applying the personalized watermark 215.

In an embodiment, with reference to step 410 of FIG. 3A and step 510 of FIG. 3B, at step 320, the personalized watermark 215 can be applied to the enhancement video layer 210. For example, the provider server 190 can apply the personalized watermark 215 to the enhancement video layer 210. For example, the client server 191 can apply the personalized watermark 215 to the enhancement video layer 210.

In an embodiment, with reference to step 415a, step 415b1 and step 415b2 of FIG. 3A and step 515 of FIG. 3B, at step 325, the base video layer 205 and the enhancement video layer 210 including the personalized watermark 215 can be transmitted. For example, the provider server 190 can transmit the base video layer 205 and the enhancement video layer 210 including the personalized watermark 215 to the first device 125. For example, the client server 191 can transmit the base video layer 205 and the enhancement video layer 210 including the personalized watermark 215 to the first device 125.

In an embodiment, with reference to step 420 of FIG. 3A and step 520 of FIG. 3B, at step 330, a tampering status can be received. For example, the provider server 190 can receive the tampering status. For example, the client server 191 can receive the tampering status. The first device 125 can be in constant communication with the provider server 190 or the client server 191 and transmitting the tampering status with a certain frequency as a way to continually provide authorization of layer delivery. The tampering status can indicate whether an unauthorized user has attempted to tamper with the enhancement video layer 210. For example, the unauthorized user can attempt to remove the personalized watermark 215 from the enhancement video layer 210.

In an embodiment, at step 335, the provider server 190 can determine whether the tampering status indicates tampering as occurred. Additionally or alternatively, at step 335, the client server 191 can determine whether the tampering status indicates tampering as occurred.

In an embodiment, with reference to steps 425 and 430 of FIG. 3A and steps 525 and 530 of FIG. 3B, upon receiving a tampering status that indicates tampering has occurred, an anti-piracy process can be implemented at step 340. For example, the provider server 190 can implement the anti-piracy process. For example, the client server 191 can implement the anti-piracy process. The anti-piracy process is described further below.

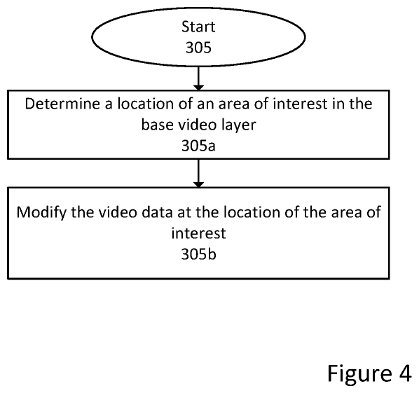

FIG. 4 is a flow chart describing the step 305 of generating the base video layer having a lower quality level, according to an embodiment of the present disclosure.

In an embodiment, at step 305a, a location of the AOI 220 in the base video layer 205 can be determined. For example, the provider server 190 can determine the location of the AOI 220 in the base video layer 205. For example, the client server 191 can determine the location of the AOI 220 in the base video layer 205.

In an embodiment, at step 305b, the video data at the location of the AOI 220 can be modified to further decrease the first quality level of the base video layer 205. For example, the provider server 190 can modify the video data at the location of the AOI 220. For example, the client server 191 can modify the video data at the location of the AOI 220.

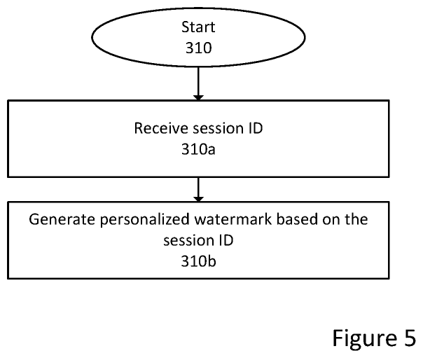

FIG. 5 is a flow chart describing the step 310 of generating the personalized watermark, according to an embodiment of the present disclosure.

In an embodiment, at step 310a, the session ID can be received. The session ID can include, for example, device hardware ID, anonymized device ID, device private identity certificates, user ID, IP address, password, device model, geolocation, browser fingerprint, or any data that can be used to fingerprint the device originating the pirated video data. For example, the provider server 190 can receive the session ID from the client server 191. For example, the client server 191 can receive the session ID from the first device 125.

In an embodiment, at step 310b, the personalized watermark 215 can be generated based on the session ID. For example, the provider server 190 can generate the personalized watermark 215 based on the session ID received from the client server 191. For example, the client server 191 can generate the personalized watermark 215 based on the session ID received from the first device 125.

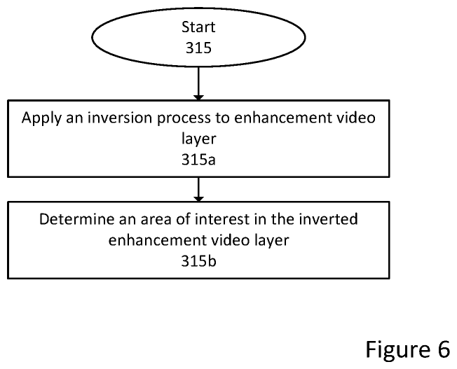

FIG. 6 is a flow chart describing the step 315 of determining the location for applying the personalized watermark, according to an embodiment of the present disclosure.

In an embodiment, at step 315a, an inversion process can be applied to the enhancement video layer 210. For example, the provider server 190 can apply the inversion process to the enhancement layer 210. For example, the client server 191 can apply the inversion process to the enhancement layer 210.

In an embodiment, at step 315b, an AOI in the inverted enhancement layer 210 can be determined. For example, the provider server 190 can determine the AOI in the inverted enhancement layer 210. For example, the client server 191 can determine the AOI in the inverted enhancement layer 210.

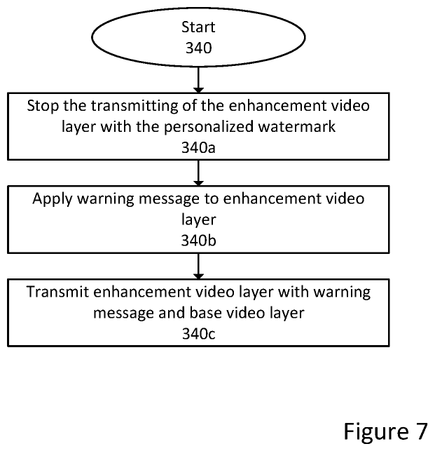

FIG. 7 is a flow chart describing the step 340 of implementing the anti-piracy process, according to an embodiment of the present disclosure.

In an embodiment, with reference to step 425 of FIG. 3A and step 525 of FIG. 3B, at step 340a, the transmitting of the enhancement video layer 210 with the personalized watermark 215 can be stopped. Notably, the base video layer 205 can optionally still be transmitted without worry of the base video layer 205 being pirated since the first quality level makes the SD video already difficult to view. For example, the provider server 190 can stop the transmitting of the enhancement video layer 210 with the personalized watermark 215. For example, the client server 191 can stop the transmitting of the enhancement video layer 210 with the personalized watermark 215. In effect, this can relegate the unauthorized user to only obtaining and viewing (or distributing) the SD video quality of the base video layer 205 in the optional scenario where the base video layer 205 is still transmitted.

In an embodiment, at step 340b, a warning message can be applied to the enhancement video layer 210. The warning message can include a graphic or text, and the warning message can be visible when applied to the enhancement video layer 210. For example, the words “STOP PIRATING THIS VIDEO” can be applied to the enhancement video layer 210 as the warning message, which can obscure some or most of the base video layer 205 when the enhancement video layer 210 is overlaid. For example, the provider server 190 can apply the warning message to the enhancement video layer 210. For example, the client server 191 can apply the warning message to the enhancement video layer 210.

In an embodiment, with reference to step 430 of FIG. 3A and step 430 of FIG. 3B, at step 340c, the enhancement video layer 210 with the warning message and the base video layer 205 can be transmitted. For example, the provider server 190 can transmit the enhancement video layer 210 with the warning message and the base video layer 205. For example, the client server 191 can transmit the enhancement video layer 210 with the warning message and the base video layer 205. Notably, with the warning message in the enhancement video layer 210 overlaid on the base video layer, even the combined video layer 230 will be difficult to view since the warning message can obscure important portions of the combined video layer 230.

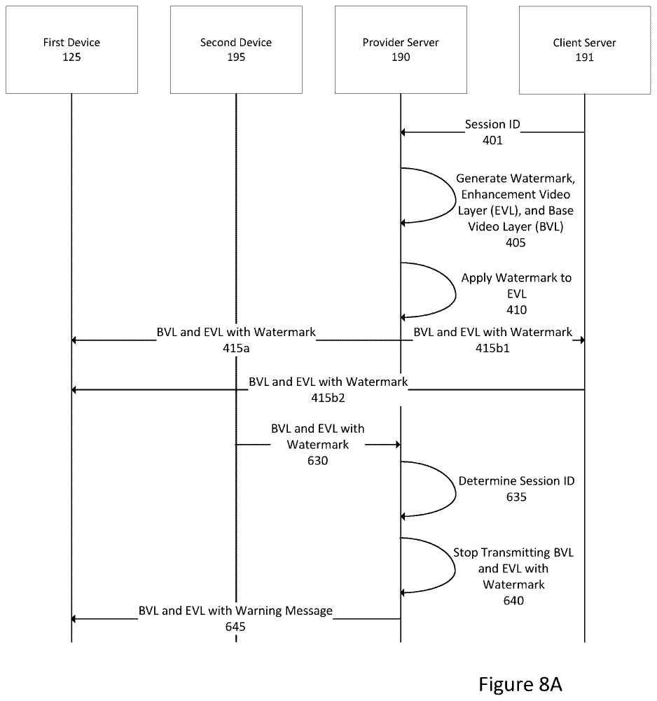

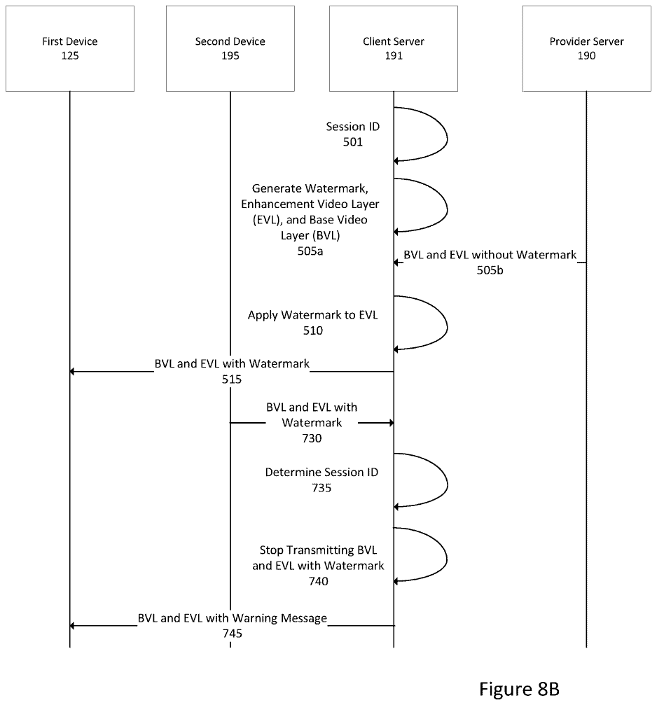

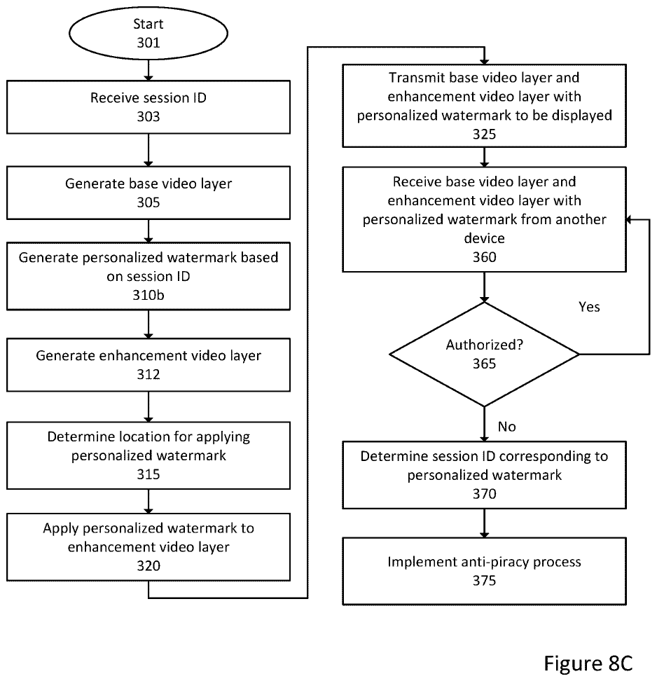

FIG. 8A and FIG. 8B show schematics of methods for applying a personalized watermark to an enhancement video layer and detecting a source device from a pirated video stream, according to an embodiment of the present disclosure. FIG. 8A and FIG. 8B will be described herein to provide an overview of the methods, and in particular, the method described in FIG. 8C.

In an embodiment, similar initial steps described in FIG. 3A and FIG. 3B can be included in the method of FIG. 8A and FIG. 8B. That is, steps 401, 405, 410, 415 a, 415b1, and 415b2 can occur at the start of the method outlined in FIG. 8A. Similarly, steps 501, 505a, 505b, 510, and 515 can occur at the start of the method outlined in FIG. 8B.

Proceeding from the step of transmitting the base video layer 205 and the enhancement video layer 210 with the personalized watermark 215, the base video layer 205 and the enhancement video layer 210 including the personalized watermark 215 generated based on the session ID can be received from the second device 195. In step 630 of FIG. 8A, the provider server 190 can receive the base video layer 205 and the enhancement video layer 210 including the personalized watermark 215 generated based on the session ID. In step 730 of FIG. 8B, the client server 191 can receive the base video layer 205 and the enhancement video layer 210 including the personalized watermark 215 generated based on the session ID.

While the first device 125 received the base video layer 205 and the enhancement video layer 210 including the personalized watermark 215, the unauthorized user can pirate the base video layer 205 and the enhancement video layer 210 including the personalized watermark 215 from the first device 125 and re-broadcast or redistribute the base video layer 205 and the enhancement video layer 210 including the personalized watermark 215 using the second device 195. Again, the personalized watermark 215 here can be generated based on the session ID.

Thus, in an embodiment, the provider server 190 can determine whether the second device 195 is authorized to be in possession of and/or be broadcasting the base video layer 205 and the enhancement video layer 210. Additionally or alternatively, in an embodiment, the client server 191 can determine whether the second device 195 is authorized to be in possession of and/or be broadcasting the base video layer 205 and the enhancement video layer 210.

In an embodiment, upon determining the second device 195 is not authorized to be in possession of and/or be broadcasting the base video layer 205 and the enhancement video layer 210, the session ID corresponding to the personalized watermark 215 in the pirated enhancement video layer 210 can be determined. In step 635 of FIG. 8A, the provider server 190 can determine the session ID corresponding to the personalized watermark 215. In step 735 of FIG. 8B, the client server 191 can determine the session ID corresponding to the personalized watermark 215. From this, the corresponding device can be determined and action against the offending corresponding device can be taken. For example, there can be many devices receiving the base video layer 205 and the enhancement video layer 210, but the determined session ID can identify the first device 125 as the device from which the pirated video stream received by the provider server 190 and/or the client server 191 originates.

In an embodiment, an anti-piracy process can be implemented against the unauthorized user on the first device 125 and/or the second device 195. Similar to the previously described anti-piracy process, the anti-piracy process can include stopping the transmitting of the base video layer 205 and/or the enhancement video layer 210 with the personalized watermark 215 generated based on the session ID. Notably, the base video layer 205 can optionally still be transmitted without worry of the base video layer 205 being pirated since the first quality level makes the SD video already difficult to view.

With reference to FIG. 8A and FIG. 8B, the stopping of the transmitting of the base video layer 205 and/or the enhancement video layer 210 with the personalized watermark 215 generated based on the session ID to the identified first device 125 is shown as step 640 in FIG. 8A and step 740 in FIG. 8B. In step 640 of FIG. 8A, the provider server 190 can stop the transmitting of the base video layer 205 and/or the enhancement video layer 210 with the personalized watermark 215 generated based on the session ID. In step 740 of FIG. 8B, the client server 191 can stop the transmitting of the base video layer 205 and/or the enhancement video layer 210 with the personalized watermark 215 generated based on the session ID.

In an embodiment, the anti-piracy process can include applying a warning message to the enhancement video layer 210 and transmitting the enhancement video layer 210 with the warning message (along with the base video layer 205). The warning message can include a graphic or text, and the warning message can be visible when applied to the enhancement video layer 210. For example, the words “STOP PIRATING THIS VIDEO” can be applied to the enhancement video layer 210 as the warning message, which can obscure some or most of the base video layer 205 when the enhancement video layer 210 is overlaid.

With reference to FIG. 8A and FIG. 8B, the transmitting of the base video layer 205 and the enhancement video layer 210 with the warning message is shown as step 645 in FIG. 8A and step 745 in FIG. 8B. In step 645 of FIG. 8A, the provider server 190 can transmit the base video layer 205 and the enhancement video layer 210 with the warning message. In step 745 of FIG. 8B, the client server 191 can transmit the base video layer 205 and the enhancement video layer 210 with the warning message.

FIG. 8C is a flow chart for a method 301 of applying the personalized watermark 215 to the enhancement video layer 210 and detecting a source device from a pirated video stream, according to an embodiment of the present disclosure. The method 301 can include similar steps as the method 300 in the beginning, with the caveat that the session ID can be used to generate the personalized watermark 215 and subsequently used to determine the source device from which the unauthorized user is obtaining the enhancement video layer 210 and the base video layer 205 for redistribution.

In an embodiment, at step 303, the session ID can be received. For example, the provider server 190 can receive the session ID. For example, the client server 191 can receive the session ID.

In an embodiment, with reference to step 405 of FIG. 8A and step 505 of FIG. 8B, at step 305, the base video layer 205 can be generated. For example, the provider server 190 can generate the base video layer 205 based on the source video data 201. For example, the client server 191 can generate the base video layer 205 based on the source video data 201.

In an embodiment, with reference to step 405 of FIG. 8A and step 505a of FIG. 8B, at step 310b, the personalized watermark 215 can be generated based on the session ID. For example, the provider server 190 can generate the personalized watermark 215 based on the session ID received from the client server 191. For example, the client server 191 can generate the personalized watermark 215 based on the session ID received from the first device 125.

In an embodiment, with reference to step 405 of FIG. 8A and step 505a of FIG. 8B, at step 312, the enhancement video layer 210 can be generated. For example, the provider server 190 can generate the enhancement video layer 210. For example, the client server 191 can generate the enhancement video layer 210.

In an embodiment, at step 315, a location in the enhancement video layer 210 for applying the personalized watermark 215 can be determined. For example, the provider server 190 can determine the location in the enhancement video layer 210 for applying the personalized watermark 215. For example, the client server 191 can determine the location in the enhancement video layer 210 for applying the personalized watermark 215.

In an embodiment, with reference to step 410 of FIG. 8A and step 510 of FIG. 8B, at step 320, the personalized watermark 215 can be applied to the enhancement video layer 210. Again, here the personalized watermark 215 is generated based on the session ID. For example, the provider server 190 can apply the personalized watermark 215 to the enhancement video layer 210. For example, the client server 191 can apply the personalized watermark 215 to the enhancement video layer 210.

In an embodiment, with reference to step 415a, step 415b1 and step 415b2 of FIG. 8A and step 515 of FIG. 8B, at step 325, the base video layer 205 and the enhancement video layer 210 including the personalized watermark 215 generated based on the session ID can be transmitted. For example, the provider server 190 can transmit the base video layer 205 and the enhancement video layer 210 including the personalized watermark 215 to the first device 125. For example, the client server 191 can transmit the base video layer 205 and the enhancement video layer 210 including the personalized watermark 215 to the first device 125.

In an embodiment, with reference to step 630 of FIG. 8A and step 730 of FIG. 8B, at step 360, the base video layer 205 and the enhancement video layer 210 including the personalized watermark 215 generated based on the session ID can be received. While the first device 125 was transmitted the base video layer 205 and the enhancement video layer 210 including the personalized watermark 215, the unauthorized user can pirate the base video layer 205 and the enhancement video layer 210 including the personalized watermark 215 from the first device 125 and re-broadcast or redistribute the base video layer 205 and the enhancement video layer 210 including the personalized watermark 215 using the second device 195. For example, the provider server 190 can receive the base video layer 205 and the enhancement video layer 210 including the personalized watermark 215 from the second device 195. For example, the client server 191 can receive the base video layer 205 and the enhancement video layer 210 including the personalized watermark 215 from the second device 195. As such, the pirated video stream can be received by the provider server 190 and/or the client server 191 for monitoring.

In an embodiment, at step 365, the provider server 190 can determine whether the second device 195 is authorized to be in possession of and/or be broadcasting the base video layer 205 and the enhancement video layer 210. Additionally or alternatively, at step 365, the client server 191 can determine whether the second device 195 is authorized to be in possession of and/or be broadcasting the base video layer 205 and the enhancement video layer 210.

In an embodiment, with reference to step 635 of FIG. 8A and step 735 of FIG. 8B, upon determining the second device 195 is not authorized to be in possession of and/or be broadcasting the base video layer 205 and the enhancement video layer 210, the session ID corresponding to the personalized watermark 215 in the pirated enhancement video layer 210 can be determined. For example, the provider server 190 can determine the session ID corresponding to the personalized watermark 215. For example, the client server 191 can determine the session ID corresponding to the personalized watermark 215.

In an embodiment, at step 375, an anti-piracy process can be implemented. For example, the provider server 190 can implement the anti-piracy process. For example, the client server 191 can implement the anti-piracy process. The anti-piracy process is described further below.

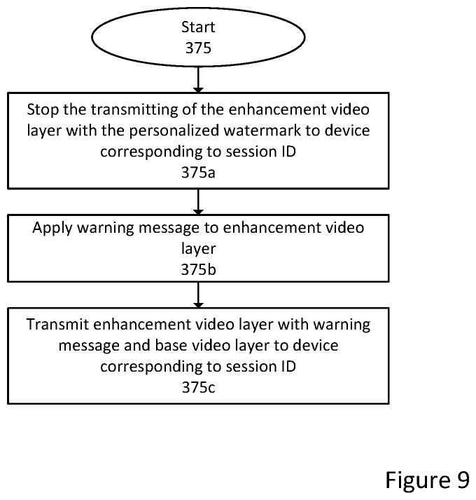

FIG. 9 is a flow chart describing the step 375 of implementing the anti-piracy process, according to an embodiment of the present disclosure.

In an embodiment, with reference to step 640 of FIG. 8A and step 740 of FIG. 8B, at step 375a, the transmitting of the enhancement video layer 210 with the personalized watermark 215 to the device corresponding to the session ID can be stopped. Notably, the base video layer 205 can optionally still be transmitted without worry of the base video layer 205 being pirated since the first quality level makes the SD video already difficult to view. For example, even though the pirated video stream was received from the second device 195, since the session ID used to generate the personalized watermark 215 corresponds to the first device 125, the transmitting to the first device 125 can be stopped. In the event the unauthorized user is obtaining the video stream from the first device 125, the unauthorized user will stop receiving the video stream for redistribution via the second device 195. For example, the provider server 190 can stop the transmitting of the enhancement video layer 210 with the personalized watermark 215. For example, the client server 191 can stop the transmitting of the enhancement video layer 210 with the personalized watermark 215.

In an embodiment, at step 375b, a warning message can be applied to the enhancement video layer 210. For example, the provider server 190 can apply the warning message to the enhancement video layer 210. For example, the client server 191 can apply the warning message to the enhancement video layer 210.

In an embodiment, with reference to step 645 of FIG. 8A and step 745 of FIG. 8B, at step 375c, the enhancement video layer 210 with the warning message and the base video layer 205 can be transmitted to the device corresponding to the session ID. For example, the provider server 190 can transmit the enhancement video layer 210 with the warning message and the base video layer 205. For example, the client server 191 can transmit the enhancement video layer 210 with the warning message and the base video layer 205.

Embodiments of the subject matter and the functional operations described in this specification can be implemented by digital electronic/processing circuitry (on one or more of devices 125, 190, 191, 195, etc.), in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus, such as the devices of FIG. 1 (e.g., devices 125, 190, 191, 195, etc.) or the like. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

Electronic user device 20 shown in FIG. 10 can be an example of one or more of the devices shown in FIG. 1. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The user device 20 of FIG. 10 includes processing circuitry, as discussed above. The processing circuitry includes one or more of the elements discussed next with reference to FIG. 10. The electronic user device 20 may include other components not explicitly illustrated in FIG. 10 such as a CPU, GPU, frame buffer, etc. The electronic user device 20 includes a controller 1110 and a wireless communication processor 1102 connected to an antenna 1101. A speaker 1104 and a microphone 1105 are connected to a voice processor 1103.

The controller 1110 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 1110 may perform these functions by executing instructions stored in a memory 1150. Alternatively or in addition to the local storage of the memory 1150, the functions may be executed using instructions stored on an external device accessed on a network or on a non-transitory computer readable medium.

The memory 1150 includes but is not limited to Read Only Memory (ROM), Random Access Memory (RAM), or a memory array including a combination of volatile and non-volatile memory units. The memory 1150 may be utilized as working memory by the controller 1110 while executing the processes and algorithms of the present disclosure. Additionally, the memory 1150 may be used for long-term storage, e.g., of image data and information related thereto.

The user device 20 includes a control line CL and data line DL as internal communication bus lines. Control data to/from the controller 1110 may be transmitted through the control line CL. The data line DL may be used for transmission of voice data, displayed data, etc.

The antenna 1101 transmits/receives electromagnetic wave signals between base stations for performing radio-based communication, such as the various forms of cellular telephone communication. The wireless communication processor 1102 controls the communication performed between the user device 20 and other external devices via the antenna 1101. For example, the wireless communication processor 1102 may control communication between base stations for cellular phone communication.

The speaker 1104 emits an audio signal corresponding to audio data supplied from the voice processor 1103. The microphone 1105 detects surrounding audio and converts the detected audio into an audio signal. The audio signal may then be output to the voice processor 1103 for further processing. The voice processor 1103 demodulates and/or decodes the audio data read from the memory 1150 or audio data received by the wireless communication processor 1102 and/or a short-distance wireless communication processor 1107. Additionally, the voice processor 1103 may decode audio signals obtained by the microphone 1105.

The user device 20 may also include a display 1120, a touch panel 1130, an operation key 1140, and a short-distance communication processor 1107 connected to an antenna 1106. The display 1120 may be a Liquid Crystal Display (LCD), an organic electroluminescence display panel, or another display screen technology. In addition to displaying still and moving image data, the display 1120 may display operational inputs, such as numbers or icons which may be used for control of the user device 20. The display 1120 may additionally display a GUI for a user to control aspects of the user device 20 and/or other devices. Further, the display 1120 may display characters and images received by the user device 20 and/or stored in the memory 1150 or accessed from an external device on a network. For example, the user device 20 may access a network such as the Internet and display text and/or images transmitted from a Web server.

The touch panel 1130 may include a physical touch panel display screen and a touch panel driver. The touch panel 1130 may include one or more touch sensors for detecting an input operation on an operation surface of the touch panel display screen. The touch panel 1130 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 1130 may detect when the stylus approaches/contacts the operation surface of the touch panel display (similar to the case in which a finger is used for the touch operation).

In certain aspects of the present disclosure, the touch panel 1130 may be disposed adjacent to the display 1120 (e.g., laminated) or may be formed integrally with the display 1120. For simplicity, the present disclosure assumes the touch panel 1130 is formed integrally with the display 1120 and therefore, examples discussed herein may describe touch operations being performed on the surface of the display 1120 rather than the touch panel 1130. However, the skilled artisan will appreciate that this is not limiting.

For simplicity, the present disclosure assumes the touch panel 1130 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 1130 may include transparent electrode touch sensors arranged in the X-Y direction on the surface of transparent sensor glass.

The touch panel driver may be included in the touch panel 1130 for control processing related to the touch panel 1130, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 1130 may detect a position of a user's finger around an edge of the display panel 1120 (e.g., gripping a protective case that surrounds the display/touch panel). Signals may be transmitted by the touch panel driver, e.g. in response to a detection of a touch operation, in response to a query from another element based on timed data exchange, etc.

The touch panel 1130 and the display 1120 may be surrounded by a protective casing, which may also enclose the other elements included in the user device 20. In an embodiment, a position of the user's fingers on the protective casing (but not directly on the surface of the display 1120) may be detected by the touch panel 1130 sensors. Accordingly, the controller 1110 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 1110 may be configured to detect which hand is holding the user device 20, based on the detected finger position. For example, the touch panel 1130 sensors may detect fingers on the left side of the user device 20 (e.g., on an edge of the display 1120 or on the protective casing), and detect a single finger on the right side of the user device 20. In this example, the controller 1110 may determine that the user is holding the user device 20 with his/her right hand because the detected grip pattern corresponds to an expected pattern when the user device 20 is held only with the right hand.

The operation key 1140 may include one or more buttons or similar external control elements, which may generate an operation signal based on a detected input by the user. In addition to outputs from the touch panel 1130, these operation signals may be supplied to the controller 1110 for performing related processing and control. In certain aspects of the present disclosure, the processing and/or functions associated with external buttons and the like may be performed by the controller 1110 in response to an input operation on the touch panel 1130 display screen rather than the external button, key, etc. In this way, external buttons on the user device 20 may be eliminated in lieu of performing inputs via touch operations, thereby improving watertightness.

The antenna 1106 may transmit/receive electromagnetic wave signals to/from other external apparatuses, and the short-distance wireless communication processor 1107 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 1107.

The user device 20 may include a motion sensor 1108. The motion sensor 1108 may detect features of motion (i.e., one or more movements) of the user device 20. For example, the motion sensor 1108 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 1108 may generate a detection signal that includes data representing the detected motion. For example, the motion sensor 1108 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 1110, whereby further processing may be performed based on data included in the detection signal. The motion sensor 1108 can work in conjunction with a Global Positioning System (GPS) section 1160. The information of the present position detected by the GPS section 1160 is transmitted to the controller 1110. An antenna 1161 is connected to the GPS section 1160 for receiving and transmitting signals to and from a GPS satellite.

The user device 20 may include a camera section 1109, which includes a lens and shutter for capturing photographs of the surroundings around the user device 20. In an embodiment, the camera section 1109 captures surroundings of an opposite side of the user device 20 from the user. The images of the captured photographs can be displayed on the display panel 1120. A memory section saves the captured photographs. The memory section may reside within the camera section 109 or it may be part of the memory 1150. The camera section 1109 can be a separate feature attached to the user device 20 or it can be a built-in camera feature.

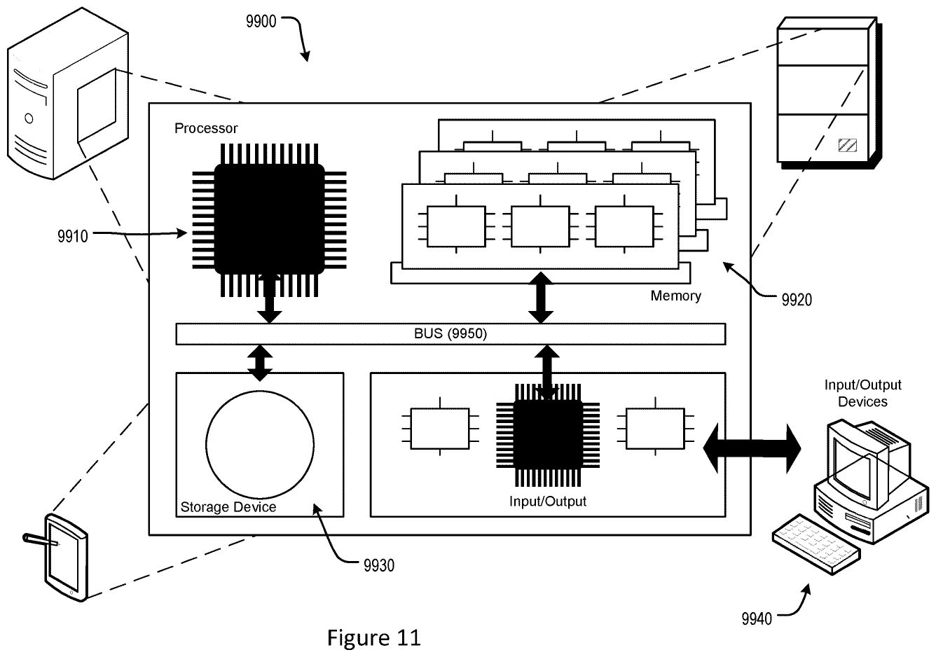

An example of a type of computer is shown in FIG. 11. The computer 9900 can be used for the operations described in association with any of the computer-implement methods described previously, according to one implementation. For example, the computer 9900 can be an example of devices 125, 195, or a server (such as the provider server 190 and the client server 191). The computer 9900 includes processing circuitry, as discussed above. The provider server 190 and the client server 191 can include other components not explicitly illustrated in FIG. 11 such as a CPU, GPU, frame buffer, etc. The processing circuitry includes one or more of the elements discussed next with reference to FIG. 11. In FIG. 11, the computer 9900 includes a processor 9910, a memory 9920, a storage device 9930, and an input/output device 9940. Each of the components 9910, 9920, 9930, and 9940 are interconnected using a system bus 9950. The processor 9910 is capable of processing instructions for execution within the system 9900. In one implementation, the processor 9910 is a single-threaded processor. In another implementation, the processor 9910 is a multi-threaded processor. The processor 9910 is capable of processing instructions stored in the memory 9920 or on the storage device 9930 to display graphical information for a user interface on the input/output device 9940.

The memory 9920 stores information within the computer 9900. In one implementation, the memory 9920 is a computer-readable medium. In one implementation, the memory 9920 is a volatile memory unit. In another implementation, the memory 9920 is a non-volatile memory unit.

The storage device 9930 is capable of providing mass storage for the computer 9900. In one implementation, the storage device 9930 is a computer-readable medium. In various different implementations, the storage device 9930 may be a floppy disk device, a hard disk device, an optical disk device, or a tape device.

The input/output device 9940 provides input/output operations for the computer 9900. In one implementation, the input/output device 9940 includes a keyboard and/or pointing device. In another implementation, the input/output device 9940 includes a display unit for displaying graphical user interfaces.

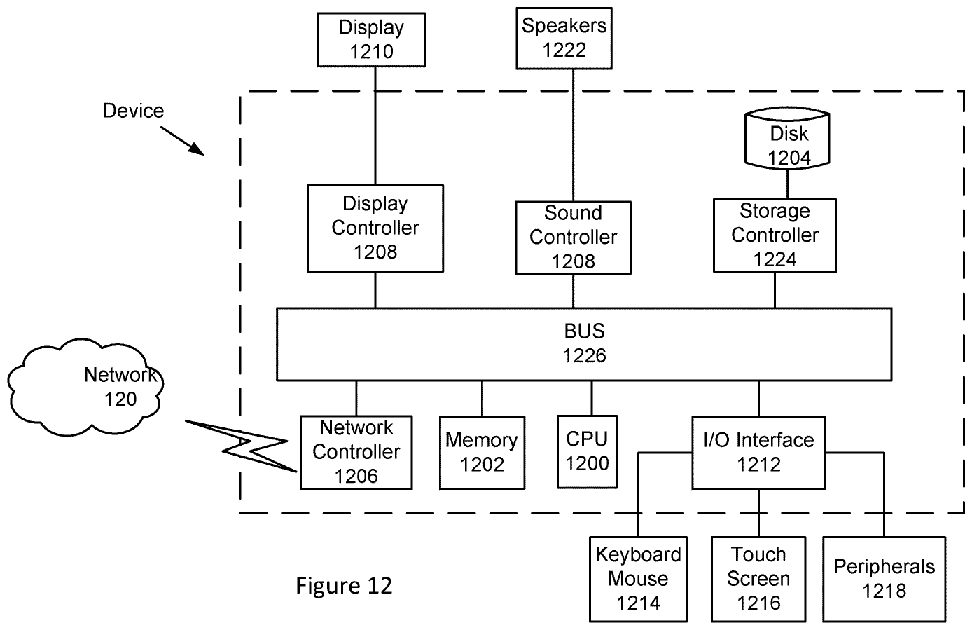

Next, a hardware description of a device according to the present embodiments is described with reference to FIG. 12. In FIG. 12, the device 1201, which can be the above-described devices of FIG. 1, includes processing circuitry, as discussed above. The processing circuitry includes one or more of the elements discussed next with reference to FIG. 12. The device can include other components not explicitly illustrated in FIG. 12, such as a CPU, GPU, frame buffer, etc. In FIG. 12, the device includes a CPU 1200 which performs the processes described above/below. The process data and instructions may be stored in memory 1202. These processes and instructions may also be stored on a storage medium disk 1204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 1201 communicates, such as a server or computer.

Further, the claimed advancements may be provided as a utility application, background daemon, or component of an operating system, or combination thereof, executing in conjunction with CPU 1200 and an operating system such as Microsoft Windows, UNIX, Solaris, LINUX, Apple MAC-OS and other systems known to those skilled in the art.

The hardware elements in order to achieve the device 1201 may be realized by various circuitry elements, known to those skilled in the art. For example, CPU 1200 may be a Xenon or Core processor from Intel of America or an Opteron processor from AMD of America, or may be other processor types that would be recognized by one of ordinary skill in the art. Alternatively, the CPU 1200 may be implemented on an FPGA, ASIC, PLD or using discrete logic circuits, as one of ordinary skill in the art would recognize. Further, CPU 1200 may be implemented as multiple processors cooperatively working in parallel to perform the instructions of the processes described above. CPU 1200 can be an example of the CPU illustrated in each of the devices of FIG. 1.

The device in FIG. 12 also includes a network controller 1206, such as an Intel Ethernet PRO network interface card from Intel Corporation of America, for interfacing with network 120 (also shown in FIG. 1), and to communicate with the other devices of FIG. 1. As can be appreciated, the network 120 can be a public network, such as the Internet, or a private network such as an LAN or WAN network, or any combination thereof and can also include PSTN or ISDN sub-networks. The network 120 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device further includes a display controller 1208, such as a NVIDIA GeForce GTX or Quadro graphics adaptor from NVIDIA Corporation of America for interfacing with display 1210, such as an LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners.

A sound controller 1220 is also provided in the device 1201 to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the device. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Additional configurations are described below:
(1) A method, including, but not limited to: applying a personalized watermark to an enhancement video layer, the enhancement video layer configured to adjust a quality level of a base video layer when applied to the base video layer, the base video layer having a first quality level, the base video layer generated from source video data.
(2) The method of (1), further including, but not limited to: determining, via a watermark template, a location for applying the personalized watermark.
(3) The method of (2), wherein: the watermark template uses one or more of transparency, brightness, hue, and/or saturation to indicate the location for applying the personalized watermark.
(4) The method of either one of (1) or (2), wherein: the watermark template is defined to extract details from the source video, thereby providing an area for the details to be reinserted in an overlay, the watermark being added to the reinserted data.
(5) The method of any one of (2)-(4), wherein the location is an area of interest in the base video layer.
(6) The method of (5), wherein the watermark template determines the area of interest in the enhancement layer by applying an inversion process to the enhancement layer.
(7) The method of (6), wherein the inversion process includes: analysing a density of video data in the enhancement video layer, identifying areas with a lower density of the video data, and providing a mask to the personalized watermark to apply to the identified areas with the lower density of the video data.
(8) The method of any one of (5)-(7), wherein the applying applies the personalized watermark at a corresponding location of the area of interest in the enhancement video layer.
(9) The method of any one of (5)-(7), wherein the applying applies the personalized watermark at a corresponding location outside the area of interest in the enhancement video layer.
(10) The method of any one of (1)-(9), wherein the enhancement video layer adjusts the quality level of the base video layer to a second quality level, the second quality level being improved compared to the first quality level.
(11) The method of any one of (1)-(10), wherein the personalized watermark is generated based on a session identification (ID).
(12) The method of (11), wherein the session ID is based on at least one of a device hardware ID, an anonymized device ID, a device private identity certificate, a user ID, an IP address, a password, a device model, a geolocation, and a browser fingerprint.
(13) The method of any one of (1)-(12), wherein the personalized watermark is received from a server configured to generate the personalized watermark based on a session ID.
(14) The method of any one of (11)-(13), further including, but not limited to: transmitting, to a first device for display, the enhancement video layer with the personalized watermark and the base video layer; receiving the base video layer and the enhancement video layer with the personalized watermark from a second device; determining whether the base video layer and the enhancement video layer with the personalized watermark from the second device are unauthorized; and upon determining the received base video layer and the enhancement video layer with the personalized watermark from the second device are unauthorized, determining the session ID corresponding to the personalized watermark.
(15) The method of any one of (11)-(13), further including, but not limited to: transmitting, to a first device for display, the enhancement video layer with the personalized watermark and the base video layer; receiving a combined video layer including the base video layer and the enhancement video layer with the personalized watermark from a second device; determining whether combined video layer from the second device is unauthorized; and upon determining the received combined video layer from the second device is unauthorized, determining the session ID corresponding to the personalized watermark.
(16) The method of either one of (14) or (15), further including, but not limited to: stopping the transmitting of the enhancement video layer with the personalized watermark to the first device corresponding to the session ID.
(17) The method of either one of (14) or (15), further including, but not limited to: applying a warning message to the enhancement video layer; and transmitting, to the first device corresponding to the session ID for display, the enhancement video layer with the warning message and the base video layer.
(18) The method of any one of (1)-(17), further including, but not limited to: transmitting, to a first device for display, the enhancement video layer with the personalized watermark and the base video layer.
(19) The method of (18), further including, but not limited to: upon receiving a status that indicates tampering has occurred, stopping the transmitting of the enhancement video layer with the personalized watermark.
(20) The method of (18), further including, but not limited to: upon receiving a status that indicates tampering has occurred, applying a warning message to the enhancement video layer and transmitting, to the first device for display, the enhancement video layer with the warning message and the base video layer.
(21) The method of any one of (1)-(20), wherein the first quality level of the base video layer is generated by removing a portion of the source video data.
(22) The method of any one of (1)-(21), wherein the first quality level of the base video layer is generated by adding degradation data to the source video data.
(23) The method of any one of (1)-(22), wherein the first quality level of the base video layer is generated by applying a transformation process to the source video data.
(24) A method, including, but not limited to: receiving, from a first device, a base video layer and an enhancement video layer with a personalized watermark applied to the enhancement video layer, the enhancement video layer configured to adjust a quality level of a base video layer when applied to the base video layer, the base video layer having a first quality level, the base video layer generated from source video data, the personalized watermark generated based on a session identification (ID); determining whether the base video layer and the enhancement video layer with the personalized watermark from the first device are unauthorized; and upon determining the received base video layer and the enhancement video layer with the personalized watermark from the first device are unauthorized, determining the session ID corresponding to the personalized watermark.
(25) A method, including, but not limited to: receiving, from a first device, a combined video layer including a base video layer and an enhancement video layer with a personalized watermark applied to the enhancement video layer, the enhancement video layer configured to adjust a quality level of a base video layer when applied to the base video layer, the base video layer having a first quality level, the base video layer generated from source video data, the personalized watermark generated based on a session identification (ID); determining whether the combined video layer from the first device is unauthorized; and upon determining the received combined video layer from the first device is unauthorized, determining the session ID corresponding to the personalized watermark.
(26) An apparatus, including, but not limited to: processing circuitry configured to: apply a personalized watermark to an enhancement video layer, the enhancement video layer configured to adjust a quality level of a base video layer when applied to the base video layer, the base video layer having a first quality level, the base video layer generated from source video data.
(27) The apparatus of (26), wherein the processing circuitry is further configured to determine, via a watermark template, a location for applying the personalized watermark.
(28) The apparatus of (27), wherein: the watermark template uses one or more of transparency, brightness, hue, and/or saturation to indicate the location for applying the personalized watermark.
(29) The apparatus of either one of (26) or (27), wherein: the watermark template is defined to extract details from the source video, thereby providing an area for the details to be reinserted in an overlay, the watermark being added to the reinserted data.
(30) The apparatus of any one of (27)-(29), wherein the location is an area of interest in the base video layer.
(31) The apparatus of (30), wherein the watermark template determines the area of interest in the enhancement layer by applying an inversion process to the enhancement layer.
(32) The apparatus of (31), wherein the inversion process includes: analysing a density of video data in the enhancement video layer, identifying areas with a lower density of the video data, and providing a mask to the personalized watermark to apply to the identified areas with the lower density of the video data.
(33) The apparatus of any one of (30)-(32), wherein the processing circuitry is further configured to apply the personalized watermark at a corresponding location of the area of interest in the enhancement video layer.
(34) The apparatus of any one of (30)-(32), wherein the processing circuitry is further configured to apply the personalized watermark at a corresponding location outside the area of interest in the enhancement video layer.
(35) The apparatus of any one of (26)-(34), wherein the enhancement video layer adjusts the quality level of the base video layer to a second quality level, the second quality level being improved compared to the first quality level.
(36) The apparatus of any one of (26)-(35), wherein the personalized watermark is generated based on a session identification (ID).
(37) The apparatus of (36), wherein the session ID is based on at least one of a device hardware ID, an anonymized device ID, a device private identity certificate, a user ID, an IP address, a password, a device model, a geolocation, and a browser fingerprint.
(38) The apparatus of any one of (26)-(37), wherein the personalized watermark is received from a server configured to generate the personalized watermark based on a session ID.
(39) The apparatus of any one of (36)-(38), wherein the processing circuitry is further configured to: transmit, to a first device for display, the enhancement video layer with the personalized watermark and the base video layer, receive the base video layer and the enhancement video layer with the personalized watermark from a second device, determine whether the base video layer and the enhancement video layer with the personalized watermark from the second device are unauthorized, and upon determining the received base video layer and the enhancement video layer with the personalized watermark from the second device are unauthorized, determine the session ID corresponding to the personalized watermark.
(40) The apparatus of any one of (26)-(38), wherein the processing circuitry is further configured to: transmit, to a first device for display, the enhancement video layer with the personalized watermark and the base video layer, receive a combined video layer including the base video layer and the enhancement video layer with the personalized watermark from a second device, determine whether combined video layer from the second device is unauthorized, and upon determining the received combined video layer from the second device is unauthorized, determine the session ID corresponding to the personalized watermark.
(41) The apparatus of either one of (39) or (40), wherein the processing circuitry is further configured to stop the transmitting of the enhancement video layer with the personalized watermark to the first device corresponding to the session ID.
(42) The apparatus of either one of (39) or (40), wherein the processing circuitry is further configured to: apply a warning message to the enhancement video layer, and transmit, to the first device corresponding to the session ID for display, the enhancement video layer with the warning message and the base video layer.
(43) The apparatus of any one of (26)-(42), wherein the processing circuitry is further configured to transmit, to a first device for display, the enhancement video layer with the personalized watermark and the base video layer.
(44) The apparatus of (43), wherein the processing circuitry is further configured to upon receiving a status that indicates tampering has occurred, stop the transmitting of the enhancement video layer with the personalized watermark.
(45) The apparatus of (43), wherein the processing circuitry is further configured to upon receiving a status that indicates tampering has occurred, apply a warning message to the enhancement video layer and transmitting, to the first device for display, the enhancement video layer with the warning message and the base video layer.
(46) The apparatus of any one of (26)-(45), wherein the first quality level of the base video layer is generated by removing a portion of the source video data.
(47) The apparatus of any one of (26)-(46), wherein the first quality level of the base video layer is generated by adding degradation data to the source video data.
(48) The apparatus of any one of (26)-(47), wherein the first quality level of the base video layer is generated by applying a transformation process to the source video data.
(49) An apparatus, including, but not limited to: processing circuitry configured to: receive, from a first device, a base video layer and an enhancement video layer with a personalized watermark applied to the enhancement video layer, the enhancement video layer configured to adjust a quality level of a base video layer when applied to the base video layer, the base video layer having a first quality level, the base video layer generated from source video data, the personalized watermark generated based on a session identification (ID), determine whether the base video layer and the enhancement video layer with the personalized watermark from the first device are unauthorized, and upon determining the received base video layer and the enhancement video layer with the personalized watermark from the first device are unauthorized, determine the session ID corresponding to the personalized watermark.
(50) An apparatus, including, but not limited to: processing circuitry configured to: receive, from a first device, a combined video layer including a base video layer and an enhancement video layer with a personalized watermark applied to the enhancement video layer, the enhancement video layer configured to adjust a quality level of a base video layer when applied to the base video layer, the base video layer having a first quality level, the base video layer generated from source video data, the personalized watermark generated based on a session identification (ID), determine whether the combined video layer from the first device is unauthorized, and upon determining the received combined video layer from the first device is unauthorized, determine the session ID corresponding to the personalized watermark.
(51) A non-transitory computer-readable medium encoded with computer-readable instructions that, when executed by a computer, causes the computer to perform a method, the method including, but not limited to: applying a personalized watermark to an enhancement video layer, the enhancement video layer configured to adjust a quality level of a base video layer when applied to the base video layer, the base video layer having a first quality level, the base video layer generated from source video data.
(52) The non-transitory computer-readable medium according to (51), further including, but not limited to: determining, via a watermark template, a location for applying the personalized watermark.
(53) The non-transitory computer-readable medium according to (52), wherein: the watermark template uses one or more of transparency, brightness, hue, and/or saturation to indicate the location for applying the personalized watermark.
(54) The non-transitory computer-readable medium according to either one of (52) or (53), wherein: the watermark template is defined to extract details from the source video, thereby providing an area for the details to be reinserted in an overlay, the watermark being added to the reinserted data.
(55) The non-transitory computer-readable medium according to any one of c(52)-(54), wherein the location is an area of interest in the base video layer.
(56) The non-transitory computer-readable medium according to (55), wherein the watermark template determines the area of interest in the enhancement layer by applying an inversion process to the enhancement layer.
(57) The non-transitory computer-readable medium according to (56), wherein the inversion process includes: analysing a density of video data in the enhancement video layer, identifying areas with a lower density of the video data, and providing a mask to the personalized watermark to apply to the identified areas with the lower density of the video data.
(58) The non-transitory computer-readable medium according to any one of (55)-(57), wherein the applying applies the personalized watermark at a corresponding location of the area of interest in the enhancement video layer.
(59) The non-transitory computer-readable medium according to any one of (55)-(57), wherein the applying applies the personalized watermark at a corresponding location outside the area of interest in the enhancement video layer.
(60) The non-transitory computer-readable medium according to any one of (51)-(59), wherein the enhancement video layer adjusts the quality level of the base video layer to a second quality level, the second quality level being improved compared to the first quality level.
(61) The non-transitory computer-readable medium according to any one of (51)-(60), wherein the personalized watermark is generated based on a session identification (ID).
(62) The non-transitory computer-readable medium according to (61), wherein the session ID is based on at least one of a device hardware ID, an anonymized device ID, a device private identity certificate, a user ID, an IP address, a password, a device model, a geolocation, and a browser fingerprint.
(63) The non-transitory computer-readable medium according to any one of (51)-(62), wherein the personalized watermark is received from a server configured to generate the personalized watermark based on a session ID.
(64) The non-transitory computer-readable medium according to any one of (61)-(63), further including, but not limited to: transmitting, to a first device for display, the enhancement video layer with the personalized watermark and the base video layer; receiving the base video layer and the enhancement video layer with the personalized watermark from a second device; determining whether the base video layer and the enhancement video layer with the personalized watermark from the second device are unauthorized; and upon determining the received base video layer and the enhancement video layer with the personalized watermark from the second device are unauthorized, determining the session ID corresponding to the personalized watermark.
(65) The non-transitory computer-readable medium according to any one of (61)-(63), further including, but not limited to: transmitting, to a first device for display, the enhancement video layer with the personalized watermark and the base video layer; receiving a combined video layer including the base video layer and the enhancement video layer with the personalized watermark from a second device; determining whether combined video layer from the second device is unauthorized; and upon determining the received combined video layer from the second device is unauthorized, determining the session ID corresponding to the personalized watermark.
(66) The non-transitory computer-readable medium according to either one of (64) or (65), further including, but not limited to: stopping the transmitting of the enhancement video layer with the personalized watermark to the first device corresponding to the session ID.
(67) The non-transitory computer-readable medium according to either one of (64) or (65), further including, but not limited to: applying a warning message to the enhancement video layer; and transmitting, to the first device corresponding to the session ID for display, the enhancement video layer with the warning message and the base video layer.
(68) The non-transitory computer-readable medium according to any one of (51)-(67), further including, but not limited to: transmitting, to a first device for display, the enhancement video layer with the personalized watermark and the base video layer.
(69) The non-transitory computer-readable medium according to (68), further including, but not limited to: upon receiving a status that indicates tampering has occurred, stopping the transmitting of the enhancement video layer with the personalized watermark.
(70) The non-transitory computer-readable medium according to (68), further including, but not limited to: upon receiving a status that indicates tampering has occurred, applying a warning message to the enhancement video layer and transmitting, to the first device for display, the enhancement video layer with the warning message and the base video layer.
(71) The non-transitory computer-readable medium according to any one of (51)-(70), wherein the first quality level of the base video layer is generated by removing a portion of the source video data.
(72) The non-transitory computer-readable medium according to any one of (51)-(71), wherein the first quality level of the base video layer is generated by adding degradation data to the source video data.
(73) The non-transitory computer-readable medium according to any one of (51)-(72), wherein the first quality level of the base video layer is generated by applying a transformation process to the source video data.
(74) A non-transitory computer-readable medium encoded with computer-readable instructions that, when executed by a computer, causes the computer to perform a method, the method including, but not limited to: receiving, from a first device, a base video layer and an enhancement video layer with a personalized watermark applied to the enhancement video layer, the enhancement video layer configured to adjust a quality level of a base video layer when applied to the base video layer, the base video layer having a first quality level, the base video layer generated from source video data, the personalized watermark generated based on a session identification (ID); determining whether the base video layer and the enhancement video layer with the personalized watermark from the first device are unauthorized; and upon determining the received base video layer and the enhancement video layer with the personalized watermark from the first device are unauthorized, determining the session ID corresponding to the personalized watermark.
(75) A non-transitory computer-readable medium encoded with computer-readable instructions that, when executed by a computer, causes the computer to perform a method, the method including, but not limited to: receiving, from a first device, a combined video layer including a base video layer and an enhancement video layer with a personalized watermark applied to the enhancement video layer, the enhancement video layer configured to adjust a quality level of a base video layer when applied to the base video layer, the base video layer having a first quality level, the base video layer generated from source video data, the personalized watermark generated based on a session identification (ID); determining whether the combined video layer from the first device is unauthorized; and upon determining the received combined video layer from the first device is unauthorized, determining the session ID corresponding to the personalized watermark.

Thus, the foregoing discussion discloses and describes merely example embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A method, comprising:
applying a personalized watermark to an enhancement video layer, the enhancement video layer configured to adjust a quality level of a base video layer when applied to the base video layer, the base video layer having a first quality level, the base video layer generated from source video data.

2. The method of claim 1, further comprising:
determining, via a watermark template, a location for applying the personalized watermark.

3. The method of claim 2, wherein:
the watermark template uses one or more of transparency, brightness, hue, and/or saturation to indicate the location for applying the personalized watermark.

4. The method of claim 1, wherein:
the watermark template is defined to extract details from the source video, thereby providing an area for the details to be reinserted in an overlay, the watermark being added to the reinserted data.

5. The method of claim 2, wherein the location is an area of interest in the base video layer.

6. The method of claim 5, wherein the watermark template determines the area of interest in the enhancement layer by applying an inversion process to the enhancement layer.

7. The method of claim 6, wherein the inversion process includes:
analysing a density of video data in the enhancement video layer,
identifying areas with a lower density of the video data, and
providing a mask to the personalized watermark to apply to the identified areas with the lower density of the video data.

8. The method of claim 5, wherein the applying applies the personalized watermark at a corresponding location of the area of interest in the enhancement video layer.

9. The method of claim 5, wherein the applying applies the personalized watermark at a corresponding location outside the area of interest in the enhancement video layer.

10. The method of claim 1, wherein the enhancement video layer adjusts the quality level of the base video layer to a second quality level, the second quality level being improved compared to the first quality level.

11. The method of claim 1, wherein the personalized watermark is generated based on a session identification (ID).

12. The method of claim 11, wherein the session ID is based on at least one of a device hardware ID, an anonymized device ID, a device private identity certificate, a user ID, an IP address, a password, a device model, a geolocation, and a browser fingerprint.

13. The method of claim 1, wherein the personalized watermark is received from a server configured to generate the personalized watermark based on a session ID.

14. The method of claim 11, further comprising:
transmitting, to a first device for display, the enhancement video layer with the personalized watermark and the base video layer;
receiving the base video layer and the enhancement video layer with the personalized watermark from a second device;
determining whether the base video layer and the enhancement video layer with the personalized watermark from the second device are unauthorized; and
upon determining the received base video layer and the enhancement video layer with the personalized watermark from the second device are unauthorized, determining the session ID corresponding to the personalized watermark.

15. The method of claim 11, further comprising:
transmitting, to a first device for display, the enhancement video layer with the personalized watermark and the base video layer;
receiving a combined video layer including the base video layer and the enhancement video layer with the personalized watermark from a second device;
determining whether combined video layer from the second device is unauthorized; and
upon determining the received combined video layer from the second device is unauthorized, determining the session ID corresponding to the personalized watermark

16. The method of claim 14, further comprising:
stopping the transmitting of the enhancement video layer with the personalized watermark to the first device corresponding to the session ID.

17. The method of claim 14, further comprising:
applying a warning message to the enhancement video layer; and
transmitting, to the first device corresponding to the session ID for display, the enhancement video layer with the warning message and the base video layer.

18. The method of claim 1, further comprising:
transmitting, to a first device for display, the enhancement video layer with the personalized watermark and the base video layer.

19. The method of claim 18, further comprising:
upon receiving a status that indicates tampering has occurred, stopping the transmitting of the enhancement video layer with the personalized watermark.

20. The method of claim 18, further comprising:
upon receiving a status that indicates tampering has occurred, applying a warning message to the enhancement video layer and transmitting, to the first device for display, the enhancement video layer with the warning message and the base video layer.
